(19) United States
(12) Patent Application Publication
(10) Pub. No.: US 2004/0078213 A1
(43) Pub. Date: Apr. 22, 2004

(54) Method, system and computer program product for dynamic construction of packages and optimal assignment of generated packages to shopping categories

(75) Inventors: Tony Brice, Colleyville, TX (US); Rebecca Kaufman, Dallas, TX (US); Eric Nespoulous, Paris (FR); Shannon O'Hara, Lewisville, TX (US); Arun Rajan, Flower Mound, TX (US); Barry Smith, Flower Mound, TX (US); Milorad Sucur, Grapevine, TX (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Sabre Inc., Southlake, TX

(21) Appl. No.: 10/464,180

(22) Filed: Jun. 18, 2003

Related U.S. Application Data
(60) Provisional application No. 60/389,797, filed on Jun. 19, 2002.

(51) Int. Cl. G06F 17/60

(52) U.S. Cl. 705/1; 705/401

(57) ABSTRACT

A method, system and computer program product for providing information relating to a plurality of packages of components, such as travel components, are provided. Typically, a plurality of candidate packages are dynamically generated in response to and in compliance with a request, such as from a consumer. To increase the options from which a consumer selects, the candidate packages that are selected, such as for display to a customer, may be evaluated based upon a diversity criteria relating to the variety of components included within the candidate packages that have been selected. Several different subsets of the candidate packages may be selected based upon an evaluation of the candidate packages in accordance with different respective value measures, such as price, relationship to the request and upgrade status.

### CROSS REFERENCE TO RELATED APPLICATION(S)

This application claims priority of U.S. Provisional Application No. 60/389,797, filed Jun. 19, 2002, the contents of which are incorporated in their entirety herein.

### BACKGROUND OF THE INVENTION

A. Field of the Invention

This invention generally relates to systems and methods for dynamically packaging items, such as products or services, for distribution or sale.

B. Description of the Related Art

The Internet is being increasingly used as an avenue for business and commerce. When utilizing the Internet to purchase various products and services, customers formulate a request for products or services that they wish to purchase. The request is submitted to a service operating a site on the Internet to complete the purchase and fulfill the requested product or service.

Currently, travel services operating sites on the Internet are capable of creating packages of travel products based on customer requests. However, the packages that are provided are limited in the diversity of the travel products and do not provide dynamic assignment of travel packages to different shopping categories to improve the shopping experience.

Accordingly, based on the deficiencies of the conventional Internet travel services, systems and methods are provided that overcome the shortcoming of existing services.

### SUMMARY OF THE INVENTION

An improved method, system and computer program product for providing information relating to a plurality of packages of components, such as travel components, are provided in accordance with various embodiments of the present invention. In accordance with one aspect of the present invention, the candidate packages that are selected, such as for display to a customer, have been evaluated based upon a diversity criteria relating to the variety of components included within the candidate packages that have been selected. As such, the customer will have a wider variety of options from which to choose. According to another aspect of the present invention, the plurality of candidate packages are dynamically generated in response to a request by a customer and several different subsets of the candidate packages are selected based upon an evaluation of the candidate packages in accordance with different respective value measures. Thus, the multiplicity of candidate packages can be sorted and organized in a manner that will be intuitive to the customer while also providing a great deal of categorized information.

According to the present invention, a request is received, such as by a request manager, that at least partially defines the requirements of a desired package of components. The plurality of candidate packages are then identified, such as by an optimization engine, such that each candidate package complies with the request. In one advantageous embodiment, for example, the plurality of candidate packages are dynamically generated, such as by the optimization engine, in response to and in compliance with the request.

At least some of the plurality of candidate packages are then selected, again typically by the optimization engine. According to one aspect of the present invention, at least some of the candidate packages are selected based upon an evaluation of the candidate packages in accordance with a diversity criteria. The diversity criteria relates to the variety of components, (e.g., the number of different components), included within the candidate packages that have been selected. By selecting the candidate packages based upon the diversity criteria, the set of candidate packages that is returned in response to the request will generally include a wider range of choices.

According to another aspect of the present invention, a respective subset of the plurality of candidate packages is selected for each of a number of different categories of packages. While various categories of packages may be defined, the method, system and computer program products of one embodiment select subsets of the plurality of candidate packages for an Ideal Trips category, a Lowest Priced Trips category and an Upgrade Trips category. Each category is associated with a different respective value measure, such as price in conjunction with the Lowest Priced Trips category, the degree of similarity to the request for the Ideal Trips category and the degree and number of upgrades relative to the request for the Upgrade Trips category. The respective subsets of the candidate packages are then selected for each respective category according to this aspect of the present invention by evaluating the candidate packages in accordance with the different respective value measures. Thus, the method, system and computer program product of this advantageous aspect of the present invention can distill a substantial quality of information into categories that are easily recognized by the customer with the contents of each category appropriately sorted by the different respective value measures.

Although described separately, the method, system and computer program product of the present invention oftentimes utilize both the diversity criteria and the different respective value measures in order to select and categorize the plurality of candidate packages. Additionally, at least some of the components may be grouped prior to identifying the plurality of candidate packages. In this regard, the air components may initially be retrieved and, based upon the air components, the car and hotel components may thereafter be retrieved so as to be grouped with the respective air components. Furthermore, at least one component of a candidate package that has been selected may be modified to include an alternative component, therefore providing the customer with additional options.

### BRIEF DESCRIPTION OF THE DRAWINGS

The accompanying drawings, which are incorporated in and constitute a part of this specification, illustrate an implementation of the invention and, together with the description that follows, serve to explain the principles of the invention. In the drawings,

FIG. 1 is a block diagram of a system in which methods and systems consistent with the present invention may be implemented;

FIG. 2 is a screen shot of a first request entry screen for entering request information, in accordance with principles consistent with the present invention;

FIG. 3 is a screen shot of a second request entry screen for entering request information, in accordance with principles consistent with the present invention;

FIG. 4 is a screen shot of results for the “Ideal Trip” category, in accordance with principles consistent with the present invention;

FIG. 5 is a screen shot of results for the “Upgrade My Trip” category, in accordance with principles consistent with the present invention;

FIG. 6 is a screen shot of results for the “Lowest Priced Trips” category, in accordance with principles consistent with the present invention;

FIG. 7 is a screen shot of results for the “Lowest Priced Trips” category with a selected package, in accordance with principles consistent with the present invention;

FIG. 8 is a screen shot of an example of the car component modification screen, in accordance with principles consistent with the present invention;

FIG. 9 is a screen shot of an example of the results of the modification of the car component, in accordance with principles consistent with the present invention;

FIG. 10 is a screen shot of an example of the hotel component modification screen, in accordance with principles consistent with the present invention;

FIG. 11 is a screen shot of an example of the results of the modification of the hotel component, in accordance with principles consistent with the present invention;

FIG. 12 is a screen shot of an example of the air component modification screen, in accordance with principles consistent with the present invention;

FIG. 13 is a screen shot of an example of the results of the modification of the air component, in accordance with principles consistent with the present invention;

FIG. 14 is a diagram of an example of the grouping of the travel components, in accordance with principles consistent with the present invention;

FIG. 15A is a process diagram of an example of the package generation and selection process steps, in accordance with principles consistent with the present invention;

FIG. 15B is a flowchart of an example of the process for constructing the package sets, in accordance with principles consistent with the present invention.

FIG. 16 is a diagram illustrating an example of the application of a air/car constraint, in accordance with principles consistent with the present invention;

FIG. 17 is a diagram illustrating an example of the application of air/car constraint, in accordance with principles consistent with the present invention;

FIG. 18 is a diagram illustrating an example of the application of an air/hotel constraint, in accordance with principles consistent with the present invention;

FIG. 19 is an exemplary graphical representation of the package solution space distribution across slices;

FIG. 20 is a diagram illustrating an example of the modification of an air component, in accordance with principles consistent with the present invention; and

FIG. 21 is a diagram illustrating an example of the functions used in the scoring mechanism, in accordance with principles consistent with the present invention.

### DETAILED DESCRIPTION

Reference will now be made in detail to an implementation consistent with the present invention as illustrated in the accompanying drawings. Wherever possible, the same reference numbers will be used throughout the drawings and the following description to refer to the same or like parts.

A. Introduction

Methods and systems consistent with the present invention provide an online travel service for dynamic creation of travel packages. The travel service may bundle various components of a travel itinerary (e.g., air, car, hotel, events etc.) to create travel packages, based on a user's request for travel-related components. A system consistent with principles of the present invention may comprise an optimization engine, which may be responsible for automated generation, optimization, and diversification of a package set, and the modification of the individual packages within the package set, for each of a number of shopping categories that may be pre-selected for presentation of the package set to the user.

More specifically, the optimization consistent with principles related to the present invention may provide the functions of:

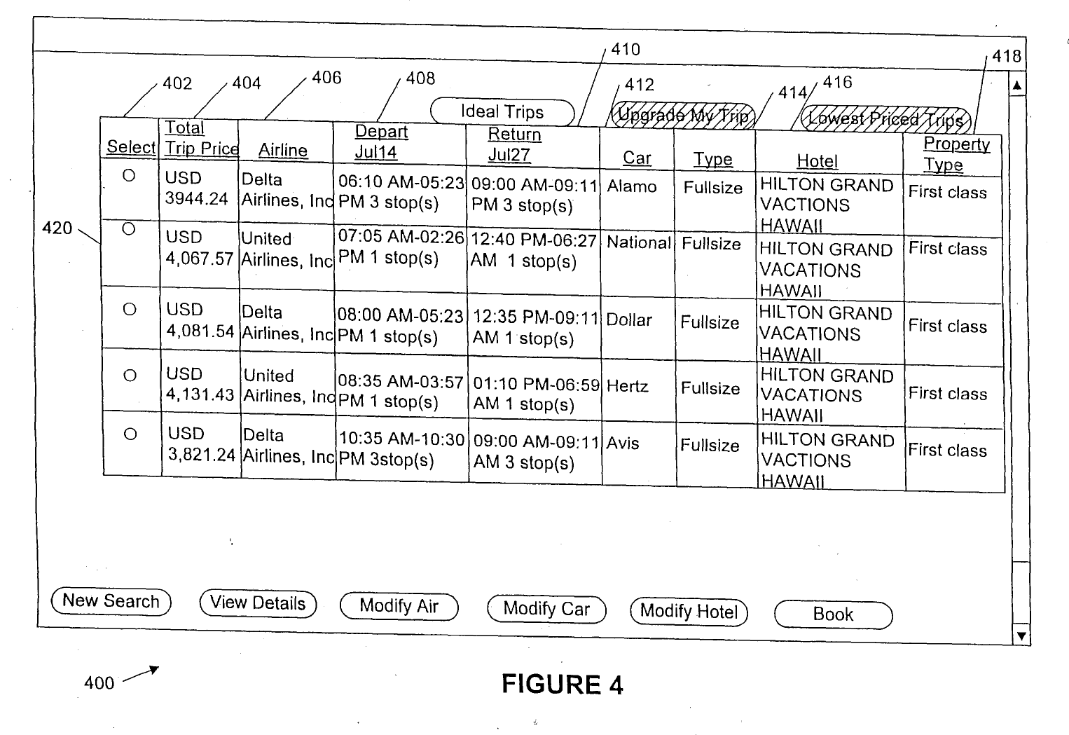

I. Generating an initial set of packages: computing the initial set of packages in response to and generally immediately after the user has initiated a request to the system (these sets of packages are presented in the initial screen for corresponding tabs as shown below in FIG. 4 for the “Ideal trips” shopping category tab);

II. Modifying the air component in the package: modifying a package selected by the user by changing its air component (initiated by choosing a package and pressing the “modify air” button on the initial package table screen as shown below in FIG. 4);

III. Modifying the car component in the package: modifying a package selected by the user by changing its car component (initiated by choosing a package and pressing the “Modify Car” button on the initial package table screen as shown below in FIG. 4);

IV. Modifying the hotel component in the package: modifying a package selected by the user by changing its hotel component (initiated by choosing a package and pressing the “Modify Hotel” button on the initial package table screen as shown below in FIG. 4).

For the purpose of this description, a travel component may be an air component, which reflects the air travel part of a travel package. It is represented by a round-trip flight itinerary between user-requested origin and destination consisting of two or more flight segments. The air component may be defined by the attributes of Table 1 below.

TABLE 1

| | |
|---|---|
| 1. | Price: price of air itinerary |
| 2. | Supplier: company supplying the air services |
| 3. | Category: what class is the itinerary booked for |
| 4. | Origin |
| 5. | Destination |
| 6. | Origin departure date and time |
| 7. | Origin arrival date and time |
| 8. | Destination arrival flight segment date and time |
| 9. | Destination departure flight segment date and time |
| 10. | Number of connections from origin to destination |
| 11. | Number of connections from destination to origin |
| 12. | Upgrade: is air component an upgrade with respect to user request |

A car component includes the car rental part of a travel package. As used herein, car is employed in a generic sense and includes cars, trucks, vans and other vehicles, without limitation. The car component may be defined by the attributes of Table 2 below.

TABLE 2

| | |
|---|---|
| 1. | Price: total price of car rental |
| 2. | Supplier: company supplying car rental |
| 3. | Category: what type of car is being rented (e.g. premium, |
| | convertible, etc.) |
| 4. | Car rental pickup location |
| 5. | Car rental drop-off location |
| 6. | Score: what is the score with respect to user-requested features of a |
| | car rental |
| 7. | Upgrade: is a car component an upgrade with respect to user request |

A hotel component refers to a lodging part of a travel package. The hotel component may be defined by the attributes of Table 3 below.

TABLE 3

| | |
|---|---|
| 1. | Price: total price of lodging |
| 2. | Supplier: company supplying the lodging services |
| 3. | Category: hotel class (e.g. luxury, moderate, bread & breakfast etc.) |
| 4. | Hotel location |
| 5. | Distance from point of interest (POI) |
| 6. | Property name |
| 7. | Score: what is the score with respect to user-requested features for |
| | lodging |
| 8. | upgrade: is a hotel component an upgrade with respect to user request |

In accordance with embodiments of the present invention, the travel packages may consist of one or more travel components, such as one or more of the air, car and hotel components and/or one or more other travel components. In addition, while examples of the attributes of the air component, car component and hotel component are provided by Tables 1, 2 and 3, respectively, these components could have additional and/or different attributes in other situations.

B. System Architecture

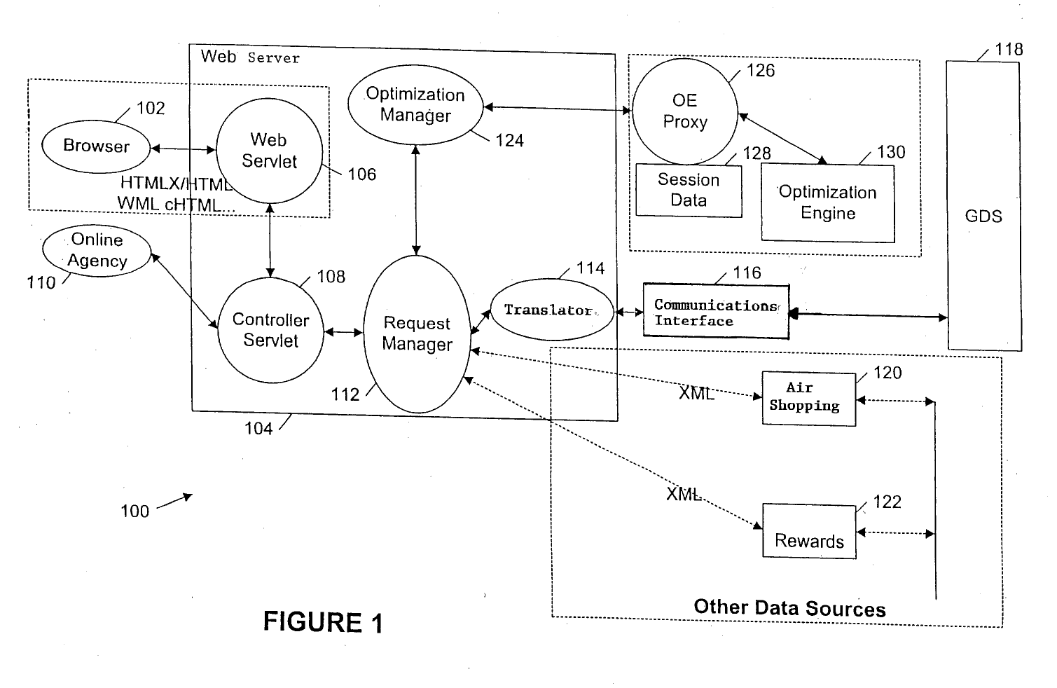

FIG. 1 illustrates a system architecture 100 consistent with principles related to the present invention. In FIG. 1, a browser 102 is provided for a user to submit a request to the web server 104. The request may be transferred from browser 102 to web server 104 using HTML, X/HTML, WML, cHTML, or any other type of electronic data interchange protocol. Servlets and other application programs, such as those employed by the web server 104, that will be discussed below may be developed using the JAVA programming language or some other suitable programming language.

Within web server 104, the request from browser 102 may be received by web servlet 106, which transfers the request to a controller servlet 108, for example, using an XML electronic data interchange over an HTTP connection. Servlet controller 108 may alternatively accept requests from an online agency 110, for example, using an XML electronic data interchange over an HTTP connection. Online agency 110 may be another type of system user, which uses a browser (not shown) to submit a request. Controller servlet 108 contains programming code that enables the user or online agency 110 to customize the browser's base functions for controlling the way information is displayed.

Once controller servlet 108 has received the request, it transfers the request to the request manager 112, which is typically embodied by software and which submits the request, as a query, typically through a translation component 114 and a communications interface 116 to a database containing information relating to the various travel components, such as a global database system (GDS) 118 including, for example, the Sabre Global Database System. Translation component 114 and communications interface 116 may be translation mechanisms, that translate the request communicated by request manager 112, using XML electronic data interchange, to the appropriate format for a query language used for obtaining information describing travel components.

Once a query is submitted to the GDS 118 to retrieve travel component information that satisfies the user's requests, the information describing the retrieved travel components is transmitted back to request manager 112, typically through the translation component 114 and the communications interface 116, which translate the retrieved travel component information, in the query language format, to XML electronic data.

In another embodiment of the present invention, request manager 112 may submit a request or query to other database sources, such as an air shopping database 120 and a Rewards database 122. These database sources may also retrieve information related to travel components and transmit them to request manager 112, for example, using an XML electronic data interchange.

Once request manager 112 receives the travel component information from the GDS 118, air shopping database 120, and/or Rewards database, the travel component information is transmitted to an optimization manager 124. Optimization manager 124 may be a controller for managing the throughput of the requests that are submitted to the optimization engine 130 through OE proxy 126.

OE proxy 126 is typically embodied in software and manages the data communications to and from optimization engine 130, as well as manages the memory and other functions necessary for the multiple user—multiple session requests that may be submitted by users. The session data 128, stored in an associated memory device, may be used by OE proxy 126 to manage the multiple user—multiple session requests. When multiple session requests are submitted to optimization engine 130, OE proxy 126 creates the multiple instances of optimization engine 130 that are required to satisfy the submitted multi-session requests. The optimization engine is typically embodied in software, but may be embodied by a combination of hardware and software in some instances.

C. System Operation

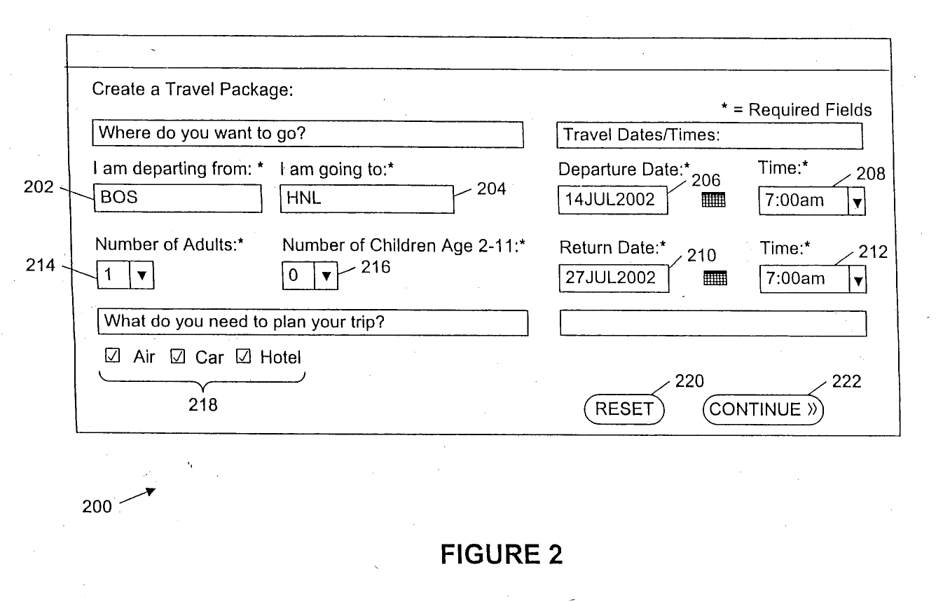

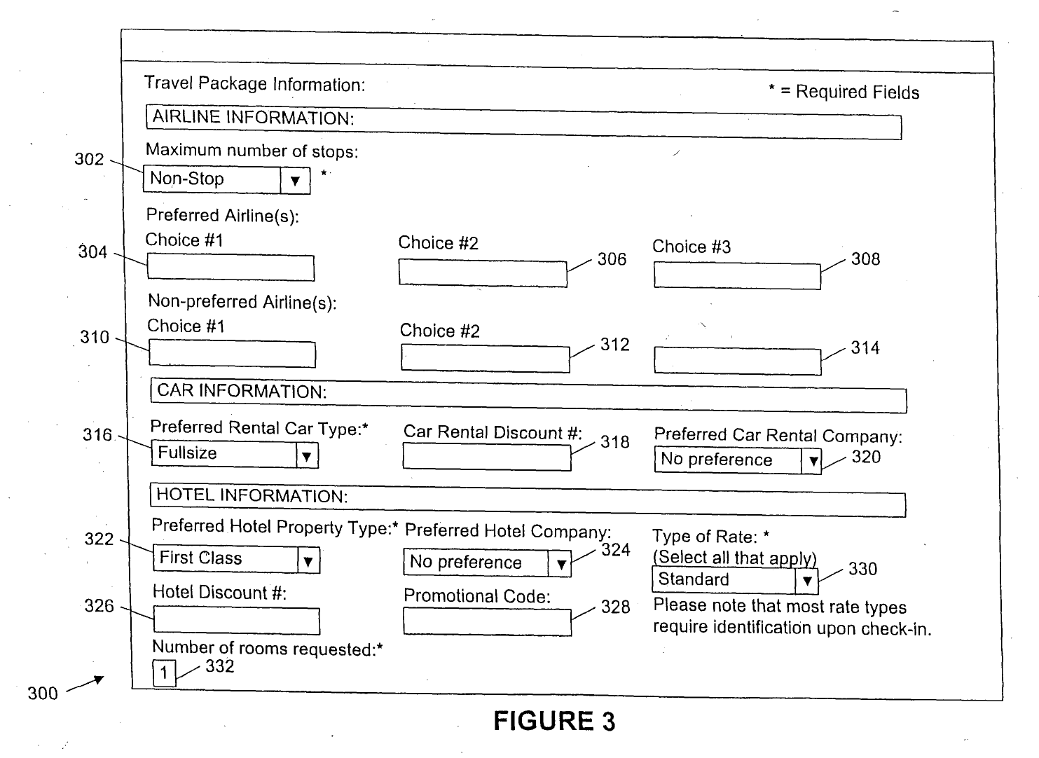

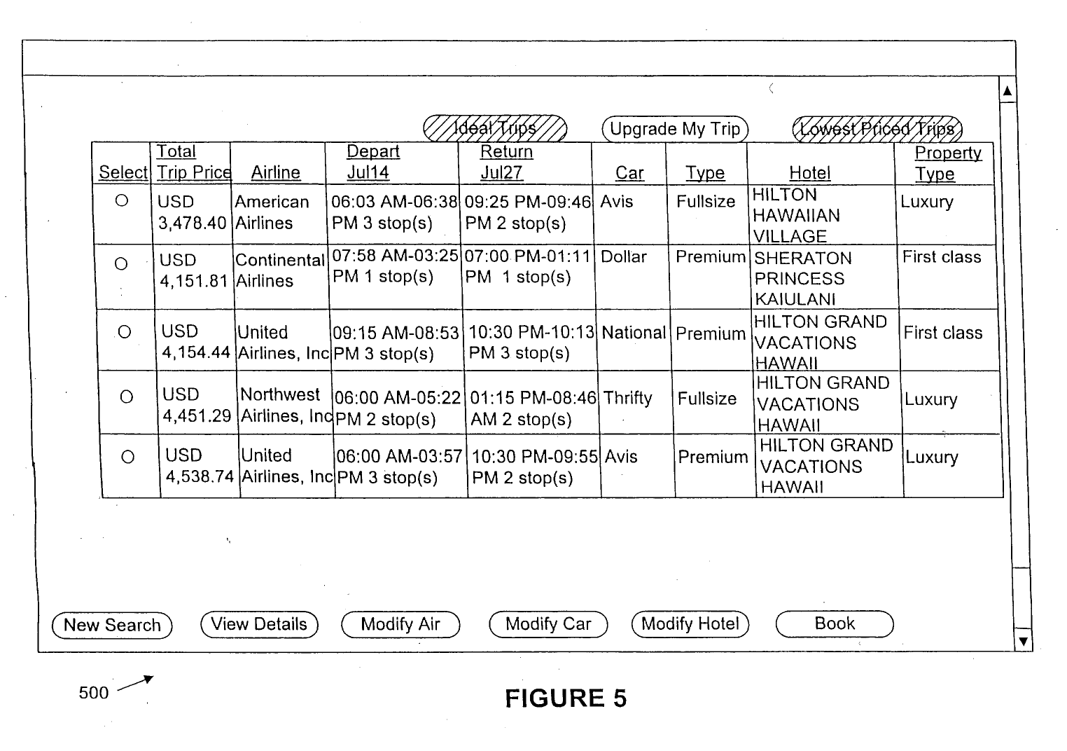

FIGS. 2-11 illustrate the operation of a system in accordance with an embodiment of the present invention. Specifically, FIGS. 2 and 3 are exemplary first and second request entry screen shots, respectively, which define the parameters of the travel package that the user may request. These parameters are transmitted through browser 102 to web server 104, when the user submits the request for the desired travel package.

FIG. 2 illustrates a screen shot of a first exemplary entry screen 200 in which the user may enter the information defining the type of package sought and its associated parameters. The user enters the desired departing and destination location, respectively (entry boxes 202 and 204). The user enters this information in response to the prompt “I am departing from” above entry box 202 and “I am going to” above entry box 204.

Further to the entry boxes (202 and 204) for the departing and destination location, screen 200 also provides entry boxes 206-214 and selection area 218. In the entry boxes, the user may enter the departure date and time and the return date and time, respectively entry boxes 206-212. The user may also enter the number of adults and the number of children ages 2-11, respectively entry boxes 214 and 216. In selection area 218, the user may select one or more of the selection boxes to indicate whether the desired travel package should include air, car, and/or hotel. The user may select button 220 to reset screen 200 or select button 222 to continue to the next entry screen.

In addition to FIG. 2, FIG. 3 provides a screen shot of a second exemplary entry screen 300 by which the user may enter the information for defining the desired travel package. In FIG. 3, the user may enter the maximum number of stops (entry box 302) that may be included in an air travel itinerary. The user may enter the names of the preferred airlines (entry boxes 304-308). The names may be entered in order of decreased preference. The user may enter the non-preferred airlines (entry boxes 310-314). The user may also enter the names of the non-preferred airlines in the order of increased dissatisfaction with the airline.

Exemplary second entry screen 300 may also allow the user to enter the car and hotel information for the desired travel package. In entry boxes 316-320, the user may enter the rental car information. The user may enter the preferred rental car type (e.g., compact, mid-size, full size, or luxury vehicle) (entry box 316), the preferred car rental company (entry box 320), and, if a preferred car rental company is selected, the car rental discount number, if one is available (entry box 318).

For the hotel information, exemplary second entry screen 300 may also allow the user to specify the preferred hotel property type (e.g., luxury, economy, or first class) (entry box 322), the preferred hotel company (entry box 324), the hotel discount number, if a preferred hotel is identified in entry box 324 (entry box 326), the promotional code, if a preferred hotel is identified in entry box 324 (entry box 328), the type of rate (e.g., a standard, a weekend, or AAA rate) (entry box 330), and the number of rooms requested (entry box 332).

Once the package information is provided through first and second entry screens 200 and 300, optimization engine 130 generates the packages. In the advantageous embodiment in which multiple shopping categories are established, the optimization engine generates a respective set of packages for each shopping category. In the illustrated embodiment, three shopping categories are established, such that the optimization engine generates three sets of packages, one for each of the three shopping categories. A shopping category may be thought of as a representative “view” of the overall package set that illustrates packages based on a certain value measure of the user's shopping preference. Packages generated by optimization engine 130 of the illustrated embodiment are presented to the user in the following three shopping categories:

I. “Lowest Priced Trips” category: the view showing lowest cost packages;

II. “Ideal Trips” category: the view showing packages that most closely match user-supplied preferences. For example, if the user requested to leave at 11:00 a.m., the package that has a flight leaving at 10:30 a.m. is “closer” to the user request than the one that leaves at 9:30 a.m.; and

III. “Upgrade My Trip” category: the view showing packages that offer an upgrade over user-supplied preferences. For example, if the user requested a moderate hotel, a package with a first class hotel room is an upgrade with respect to the user request.

FIGS. 4, 5, and 6 illustrate the initial package screens 400, 500, and 600, for each above identified categories. The packages displayed by these initial package screens have been generated by the optimization engine 130 and transmitted via the web sever 104 to the user. Initial package screens 400, 500 and 600, respectively, illustrate the initial packages for the “Ideal Trip”, the “Upgrade my trip”, and the “Lowest Priced Trips” categories. For each package displayed in initial package screens (400, 500, and 600), a plurality of information may be provided. For example, for each package displayed, a select button 402, a total trip price entry 404, an airline entry 406, a depart date entry 408, an return date entry 410, a car entry 412, a car type entry 414, a hotel entry 416, and a property type entry 418 may be provided. Once the depart and arrive date is specified in entries 408 and 410, initial package screens (400, 500 and 600) will display the flight information associated with the flight selected for the trip.

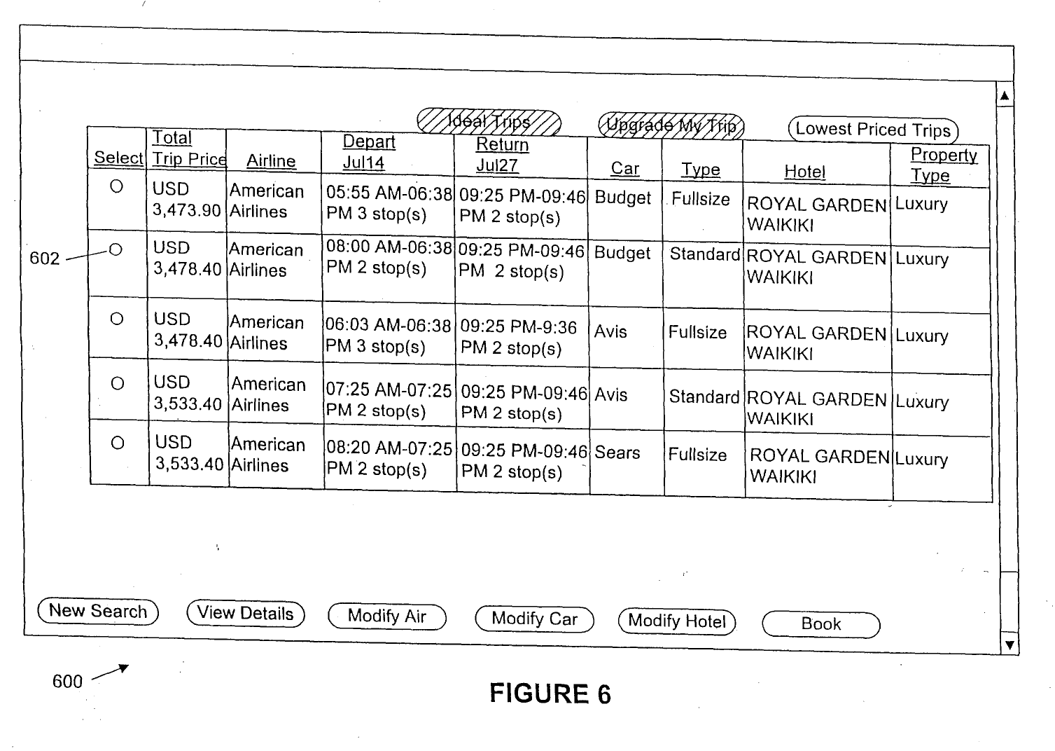

As an example of specific package information that may be displayed for the packages displayed in initial package entry screens (400, 500, and 600), the information for the second package 602 displayed in FIG. 6 will be described. In FIG. 6, second package 602 displays the total trip price ($3,473.90); the airline (American Airlines); the depart flight information (depart time (06:00 AM), arrive time (06:38 PM), and the number of stops (2 stop)); return flight information (depart time (09:25 PM), arrive time (09:46 PM), and the number of stops (2 stops); the car rental company (budget); the type of car (standard); the hotel (Royal Garden Waikiki); and the type of property (luxury).

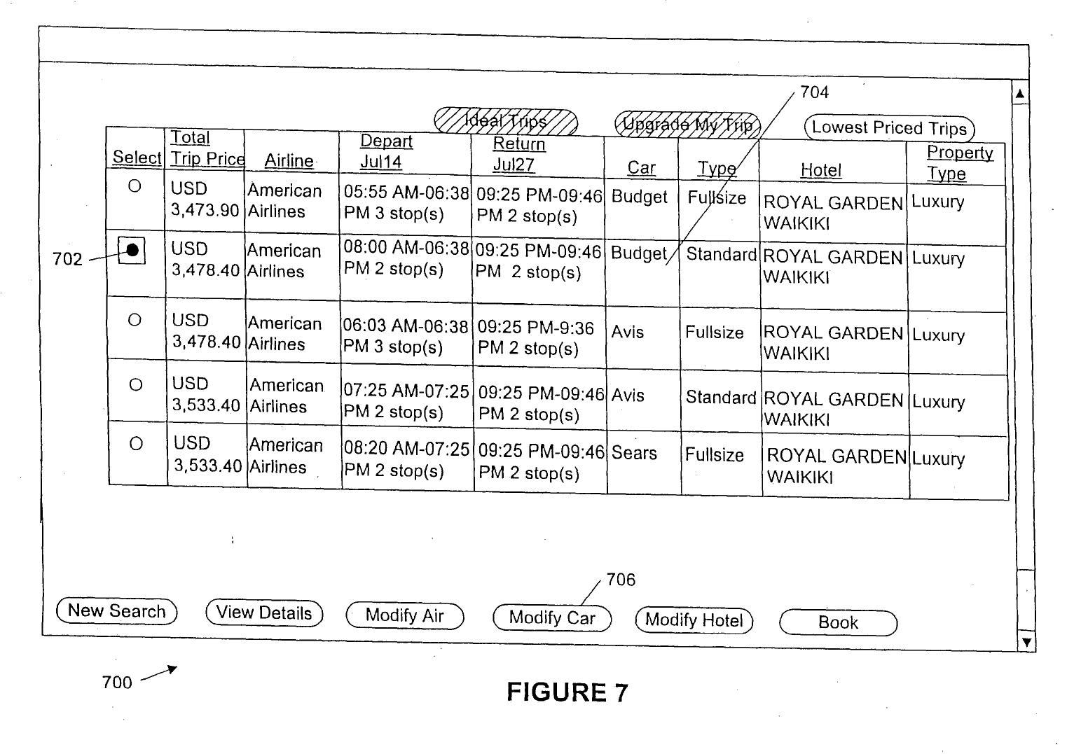

In accordance with the principles of the present invention, the embodiments of the present invention and, in the illustrated embodiment, the web server 104 in conjunction with the optimization engine 130 and one or more databases may modify any package selected from the initial set of generated packages by subsequently modifying one component type at a time by using a modification function that will be described below in conjunction with FIGS. 7-13.

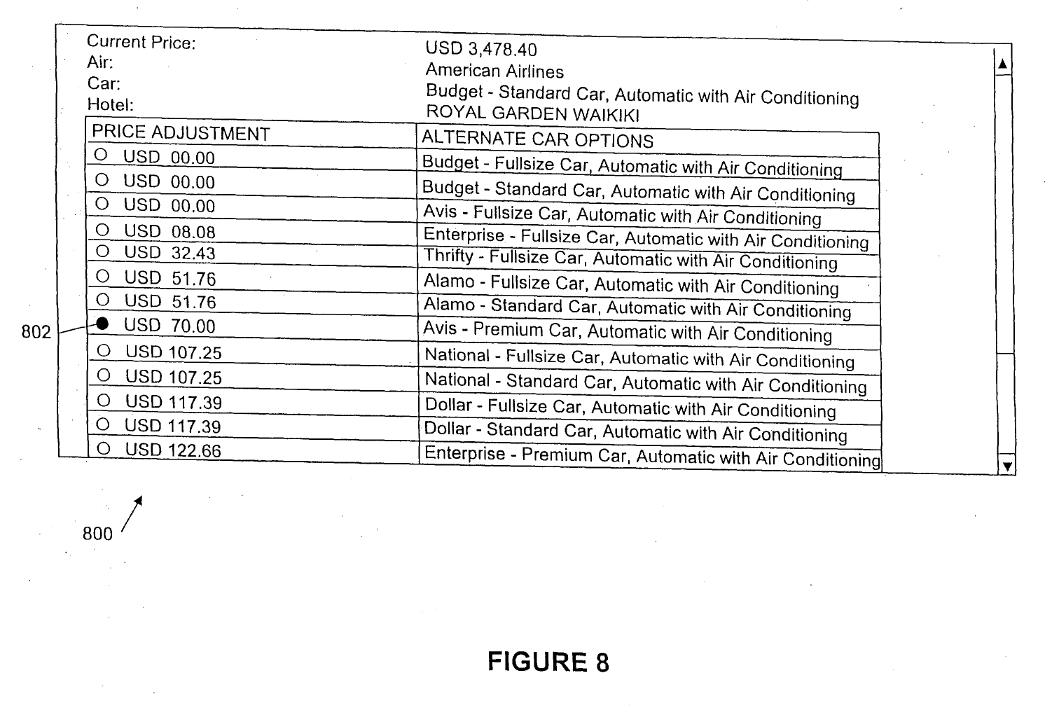

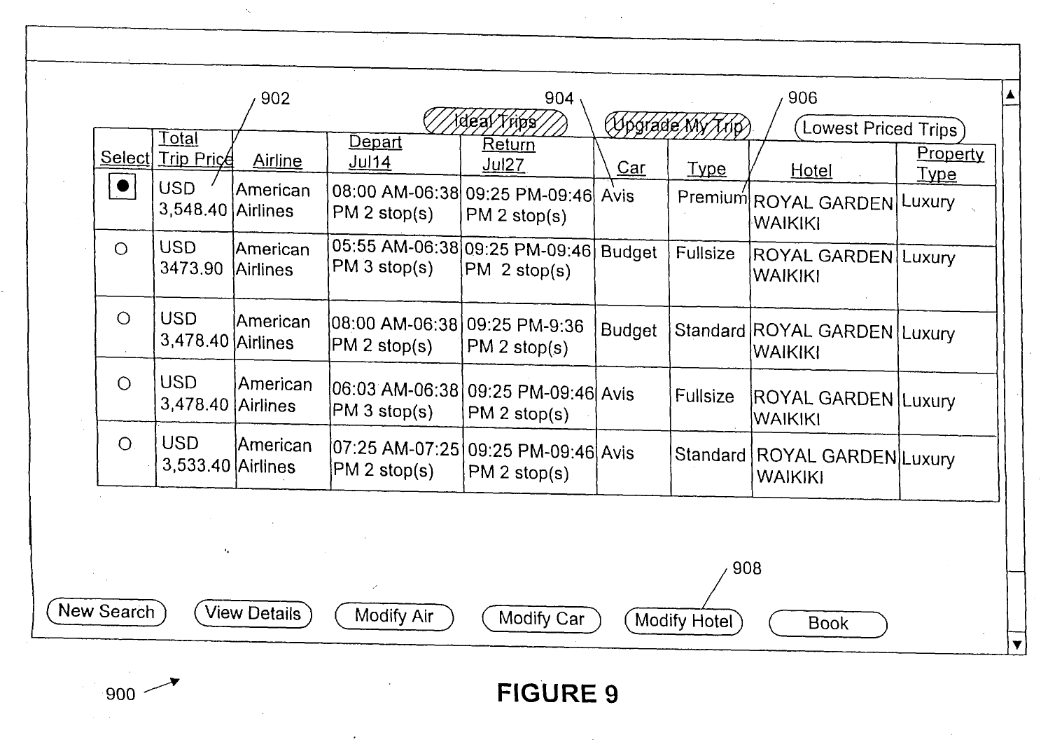

In FIG. 7, the user selects second package 602 of FIG. 6, the components having been described above, by clicking the “select button” 702. Next, to modify the car component 704 of the package, the user selects the “modify car” button 706. In response to clicking “modify car” button 706, a car modify screen 800 is displayed. Car modify screen 800 is displayed in FIG. 8. FIG. 8 illustrates that the user has decided to modify the initial car offering by selecting a new car offering 802. New car offering 802, for an additional 70 U.S. Dollars (USD 70.00), includes an Avis—premium car with automatic transmission and air conditioning. The result of modifying the car component is displayed in screen 900 of FIG. 9. Screen 900 illustrates that the total price has changed to USD 3,548.40 and the car 904 and type 906 have changed to an Avis—premium car.

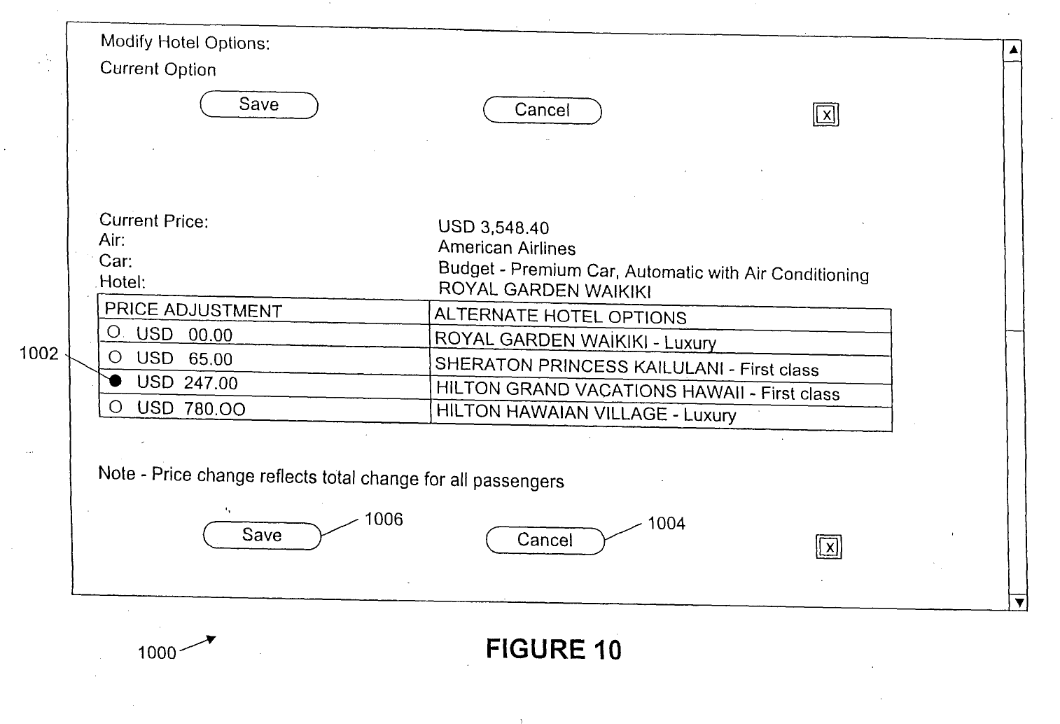

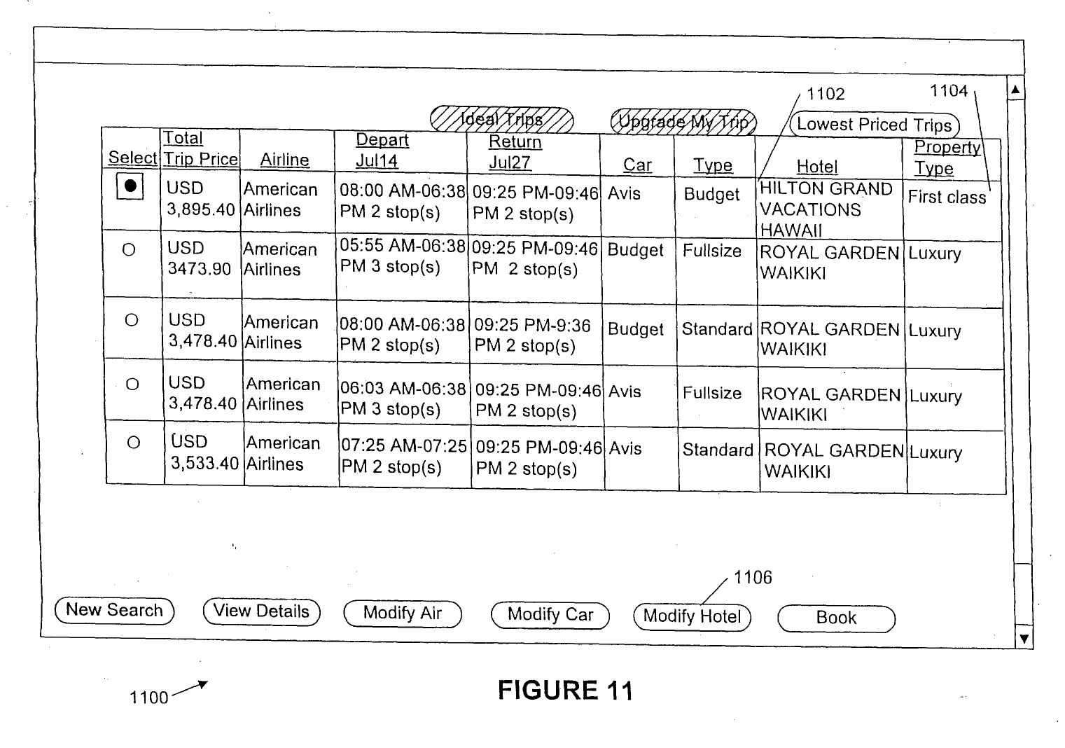

To modify the hotel component, for example, in FIG. 9, the user selects modify hotel button 908. In response to clicking “modify hotel” button 908, a hotel modify screen 1000 is displayed. Hotel modify screen 1000 is displayed in FIG. 10, which illustrates the options that a user may have to modify the initial hotel offering by selecting a new hotel offering 1002. New hotel offering 1002, with a change of 247.00 U.S. Dollars (USD 247.00) from the initial hotel offering, includes first class accommodations at Hilton Grand Vacations. The result of modifying the hotel component is displayed in screen shot 1100 of FIG. 11. Screen 1100 illustrates that the total price has changed to USD 3,895.40 and the hotel 1102 and property type 1104 have changed to Hilton Grand Vacations with first class accommodations.

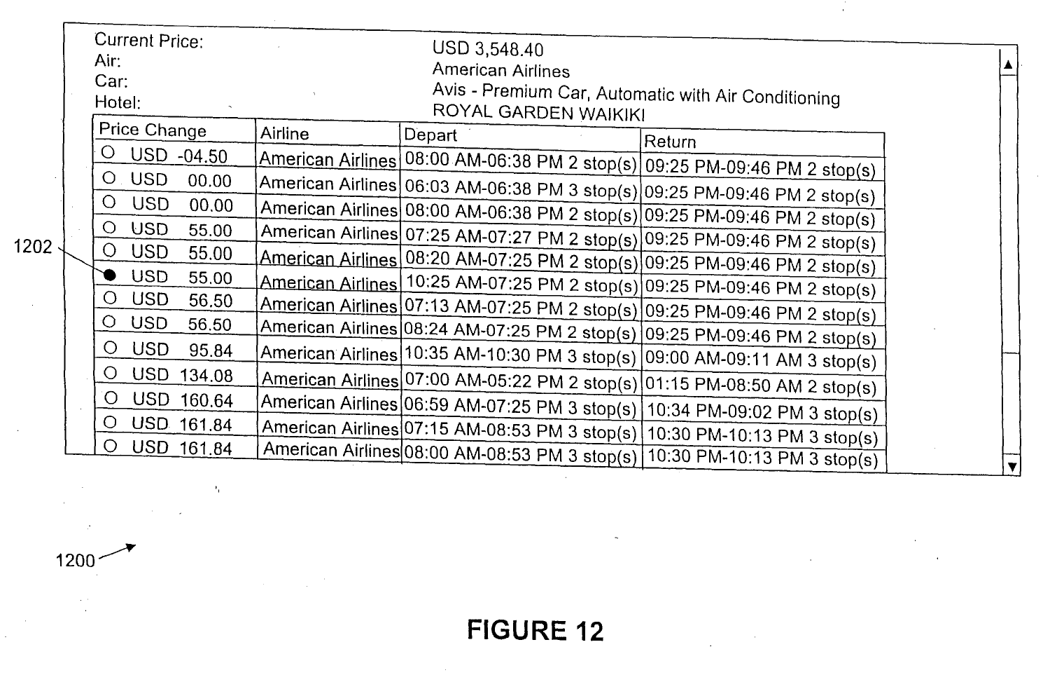

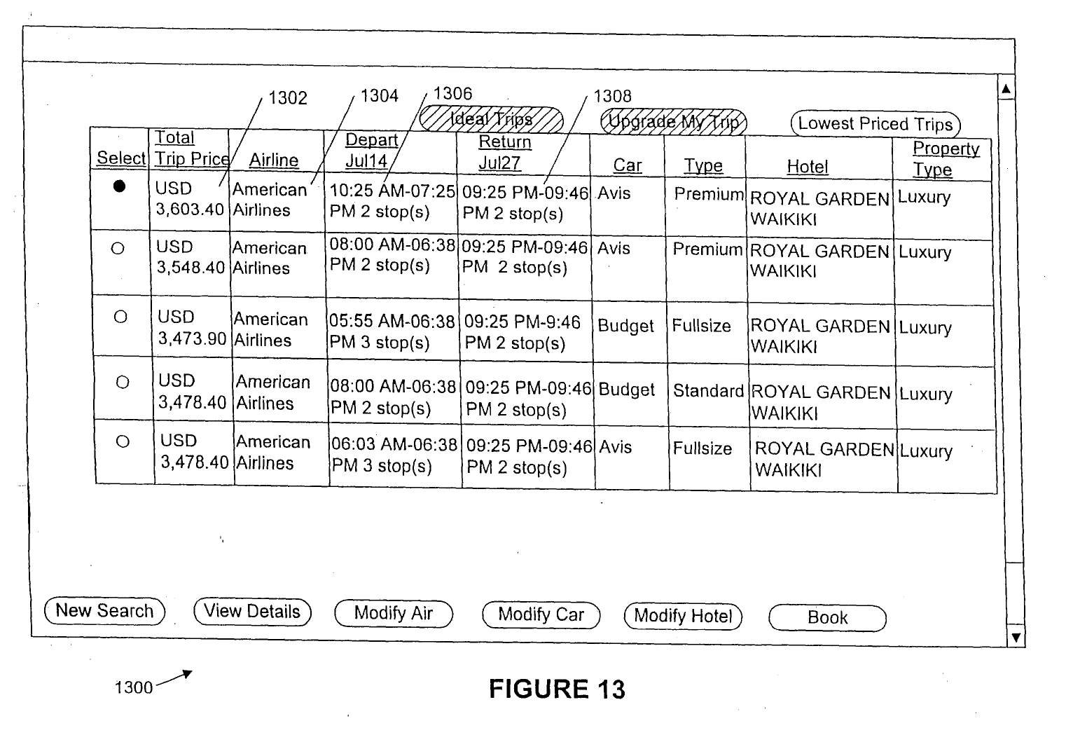

Similarly to the modification of the hotel and car components of the package, the user may also modify the airline component of the package. For example, if in FIG. 11 the user selects the modify air button 1106, a flight modify screen 1200 is displayed. Flight modify screen 1200 is displayed in FIG. 12 and illustrates the options that a user may have to modify the initial flight offering by selecting a new flight offering 1202. New flight offering 1202, with a price change of 55.00 U.S. Dollars (USD 55.00) from the initial flight offering, includes an American Airlines flight with departure flight information (depart time (10:25 AM), arrival time (7:25 PM), and number of stops (2 stops)) and return flight information (depart time (09:25 PM), arrival time (09:46 PM), and number of stops (2 stops)). The result of modifying the airline component is displayed in screen 1300 of FIG. 13. Screen 1300 illustrates that the total price 1302 has changed to USD 3,603.40 and the airline components (1302-1306) have changed to reflect the information described above for new flight offering 1202.

D. Optimization Engine Operation

D.1 Static and Dynamic Inputs

In generating the above mentioned packages, optimization engine 130 may use two general types of inputs—static and dynamic inputs. Static inputs are defined as inputs that are not directly associated with a particular user session or user request. The following inputs fall into this category: engine run-time parameters, scoring mechanism parameters, and upgrade definition codes. Each of the foregoing static inputs will be discussed in greater detail below.

On the other hand, dynamic input types are the inputs that are specific to a particular user session or request (i.e. contain dynamic data retrieved from the GDS 118 and are specific to a particular user request). The following inputs fall into this category: user request, air travel components, car travel components, and hotel travel components. The air, car, and hotel travel components, if requested, may be retrieved from the GDS 118. Each of the foregoing dynamic inputs will be discussed in greater detail below.

D.1.1 Static Inputs

The engine run-time parameters act either as discrete “switches” that can turn “off” and “on” some functionality of the engine, or as continuous control “buttons” to adjust the level of some functionality within optimization engine 130. An example of a switching parameter is the trace use parameter that turns “on” and “off” the functionality of saving the trace of engine process into a file designated for that purpose. This parameter may have a value of either 1 or 0, 1 corresponding to trace functionality turned “on” and 0 to trace functionality turned “off.” An example of continuous parameter is a maximum package price parameter that has an integer value in the range from 0 to large integer numbers. The parameters that control the following functions are described below in Table 4.

TABLE 4

| | |
|---|---|
| 1. | Trace use (switch): save engine trace to log file |
| 2. | Log info use (switch): save engine log to log file |
| 3. | Use of time report (switch): save report about engine run-times to a |
| | log file |
| 4. | Use variable names (switch): use variable names in engine model |
| | (intended mostly for engine debugging purposes) |
| 5. | Use constraint names (switch): use constraint names in engine model |
| | (intended mostly for engine debugging purposes) |
| 6. | Export input model to file (switch): export engine's own model of |
| | input data passed to the engine (useful for comparing the actual data |
| | passed to the engine to the engine's object model of the data) |
| 7. | Export LP model to file (switch): export details of engine package |
| | selection model to file (mostly useful for debugging purposes) |
| 8. | Export generated packages to file (switch): save generated packages |
| | to result file (useful for checking the details of packages generated by |
| | the engine) |
| 9. | Export selected packages to file (switch): save selected packages to |
| | result file (useful for checking the details of packages selected by the |
| | engine) |
| 10. | Export modified packages to file (switch): save modified packages to |
| | file (useful for checking the details of package modification process |
| | performed by the engine) |
| 11. | Total search time (continuous): limit the total search time to the value |
| | of this parameter. This parameter is closely linked with maximum |
| | number of packages group of parameters (one for each shopping |
| | category) and modifying it may change the behavior of the engine in |
| | a non-intuitive way. Thus, changing this parameter should be done in |
| | close coordination with the person responsible for maintaining the |
| | algorithmic portion of engine code. |
| 12. | Use pre-solve (switch): this parameter should be used only by an |
| | administrator of the engine and/or person responsible for maintaining |
| | the algorithmic portion of engine code in order to turn off and on |
| | certain functionality of the optimization module of the purchasing |
| | engine that permits faster purchase selection in certain situations. |
| 13. | Use flight upgrade (switch): controls whether an air component is |
| | used to compute the package upgrade or not. |
| 14. | Maximum number of search slices (integer): limits the number of |
| | intervals in the search space during the package generation step. Only |
| | the person responsible for maintaining the algorithmic portion of |
| | engine code should change this parameter. |
| 15. | Search slice numeric factor (continuous): coefficient that directly |
| | affects the number of regions in the search space being explored. |
| | Only the person responsible for maintaining the algorithmic portion |
| | of engine code should change this parameter. |
| 16. | Turn on air\car compatibility constraints (switch): use compatibility |
| | constraints between air and car. This parameter should be changed |
| | jointly by product manager and the person responsible for |
| | maintaining the algorithmic portion of engine code and is intended for |
| | debugging purposes only. |
| 17. | Turn on air\hotel compatibility constraints (switch): use compatibility |
| | constraints between air and hotel. This parameter should be changed |
| | jointly by product manager and the person responsible for |
| | maintaining the algorithmic portion of engine code and is intended for |
| | debugging purposes only. |
| 18. | Maximum package price (integer): limits a price of a package during |
| | the computation to this value. This parameter should be changed |
| | jointly by product manager and the person responsible for |
| | maintaining the algorithmic portion of engine code. |
| 19. | Maximum delay for car pick-up time on domestic routes (integer): |
| | number of minutes of maximum delay between an arrival of domestic |
| | flight to air itinerary destination and car pick-up time (used in air\car |
| | compatibility constraints described below). |
| 20. | Maximum delay for car drop-off time on domestic routes (integer): |
| | number of minutes of maximum difference between a departure of |
| | domestic flight from air itinerary destination and car drop-off time |
| | (used in air\car compatibility constraints described below). |
| 21. | Maximum delay for car pick-up time on international routes (integer): |
| | number of minutes of maximum delay between an arrival of |
| | international flight to air itinerary destination and car pick-up time |
| | (used in air\car compatibility constraints described below). |
| 22. | Maximum delay for car drop-off time on international routes |
| | (integer): number of minutes of maximum difference between a |
| | departure of international flight from air itinerary destination and car |
| | drop-off time (used in air\car compatibility constraints |
| | described below). |
| 23. | Inbound air\hotel threshold - hours (integer): hours in inbound |
| | threshold for determining number of required nights (used in air\hotel |
| | compatibility constraints described below). |
| 24. | Inbound air\hotel threshold - minutes (integer): minutes in inbound |
| | threshold for determining number of required nights (used in air\hotel |
| | compatibility constraints described below). |
| 25. | Outbound air\hotel threshold - hours (integer): hours in outbound |
| | threshold for determining number of required nights (used in air\hotel |
| | compatibility constraints described below). |
| 26. | Outbound air\hotel threshold - minutes (integer): minutes in |
| | outbound threshold for determining number of required nights (used |
| | in air\hotel compatibility constraints described below). |
| 27. | Maximum number of packages for price (integer): limits the number |
| | of packages generated for “Lowest Priced Trips” shopping category |
| | during the package generation step. This parameter directly affects |
| | the run-time performance as well as the quality of solution the |
| | engine returns. This parameter should be changed jointly by product |
| | manager and the person responsible for maintaining the |
| | algorithmic portion of engine code. |
| 28. | Maximum number of packages for score (integer): limits the number |
| | of packages generated for “Ideal Trips” shopping category during |
| | the package generation step. This parameter directly affects the run- |
| | time performance as well as the quality of solution the engine returns. |
| | This parameter should be changed jointly by product manager and |
| | the person responsible for maintaining the algorithmic portion of |
| | engine code. |
| 29. | Maximum number of packages for upgrade (integer): limits the |
| | number of packages generated for “Upgrade my trip” shopping |
| | category during the package generation step. This parameter |
| | directly affects the run-time performance as well as the quality of |
| | solution the engine returns. This parameter should be changed jointly |
| | by product manager and the person responsible for maintaining |
| | the algorithmic portion of engine code. |
| 30. | Maximum selection size for price (integer): limits the number of |
| | packages selected in the package selection step from the “Lowest |
| | Priced Trips” shopping category package set. |
| 31. | Maximum selection size for score (integer): limits the number of |
| | packages selected in the package selection step from the “Ideal Trips” |
| | shopping category package set. |
| 32. | Maximum selection size for upgrade (integer): limits the number of |
| | packages selected in the package selection step from the “Upgrade |
| | my trip” shopping category package set. |
| 33. | Diversity emphasis for price (continuous): parameter with a value |
| | between 0 and 1 controls the amount of package diversity to be |
| | applied in the package selection step for the “Lowest Priced |
| | Trips” shopping category package set. |
| 34. | Diversity emphasis for score (continuous): parameter with a value |
| | between 0 and 1 controls the amount of package diversity to be |
| | applied in the package selection step for the “Ideal Trips” |
| | shopping category package set. |
| 35. | Diversity emphasis for upgrade (continuous): parameter with a value |
| | between 0 and 1 controls the amount of package diversity to be |
| | applied in the package selection step for the “Upgrade my |
| | trip” shopping category package set. |

Once adjusted for peak performance, the above parameters may stay the same during the operation of the service implemented by optimization engine 130. Some of the above parameters may be changed for the purposes of future code maintenance and\or testing. In any case, the above parameters should be changed in coordination with a product manager, system administrator and\or owner of the engine code.

It is recommended that a subset of the above defined parameters should be controlled and changed by product managers to maintain the optimum performance of optimization engine 130. The subset of these parameters are shown below in Table 5.

TABLE 5

| | |
|---|---|
| 1. | Use flight upgrade |
| 2. | Maximum delay for car pick-up time on domestic routes |
| 3. | Maximum delay for car drop-off time on domestic routes |
| 4. | Maximum delay for car pick-up time on international routes |
| 5. | Maximum delay for car drop-off time on international routes |
| 6. | Inbound air\hotel threshold - hours |
| 7. | Inbound air\hotel threshold - minutes |
| 8. | Outbound air\hotel threshold - hours |
| 9. | Outbound air\hotel threshold - minutes |
| 10. | Maximum selection size for price |
| 11. | Maximum selection size for score |
| 12. | Maximum selection size for upgrade |
| 13. | Diversity emphasis for price |
| 14. | Diversity emphasis for score |
| 15. | Diversity emphasis for upgrade |

Scoring-mechanism parameter inputs contain the information about scoring weights and other scoring parameters used in scoring the packages for the “Ideal Trip” category. The scoring mechanism will be discussed in greater detail below. The process of scoring is used to assess how close a given package is to an “ideal” package defined by the user request. Scoring weight represents the measure of importance of each of the parameters used in the scoring mechanism. The score obtained through the scoring mechanism for each package is used in constructing packages for the “Ideal Trip” shopping category. Below, in Table 6, are the scoring mechanism weights included in the scoring mechanism parameter inputs (the list of weights in this embodiment is divided into groups within which the weights sum up to 1).

TABLE 6

GROUP 1
Air component weight
Car component weight
Hotel component weight
GROUP 2
Air component supplier weight
Air component departure time weight
Air component return time weight
Air component number of connections weight
GROUP 3
Car component category weight
Car component supplier weight
GROUP 4
Hotel component category weight
Hotel component supplier weight
Hotel component property name weight
Hotel component distance from point of interest weight
GROUP 5
Inside threshold for time scoring
Outside threshold for time scoring
Threshold for number of connections scoring

Upgrade definition codes establish whether a package is an upgrade or not with respect to the user request. In optimization engine 130, it may be necessary to define an upgrade at both travel component and package levels.

In the component level upgrade definitions, typically, to determine that a component is an upgrade, its shopping category attribute is used. Four possibilities exist when determining if a component is an upgrade or not: i) component is strictly an upgrade; ii) component has the same category as user request; iii) component is strictly a downgrade; and iv) upgrade is not defined for this component category.

The following general upgrade criteria, based on the component's shopping category attribute, apply, to all component types:

A. if component category matches the user request it is not an upgrade; and

B. if component category A is an upgrade to component category B and component category B is an upgrade to component category C, then component category A is also an upgrade to component category C.

Component specific upgrade criteria are provided below. For defining the specific upgrade relationships between the categories of a component type a “is an upgrade to” keyword is used. In this context, the sentence A is an upgrade to B means that a component category A is an upgrade to component category B.

In the implementation of component upgrade definition, each component may be given an upgrade level denoted by an integer that can take a binary value of either 0 or 1. Upgrade level of 1 may be assigned to a component if it is determined that it may be an upgrade (case i above for determining if a component is an upgrade or not). In all other cases (cases ii, iii, and iv above for determining if a component is an upgrade or not) component may be given an upgrade level value of 0.

Examples of the component specific upgrade criteria are provided for the car and hotel component. Similar component specific upgrade criteria may be provided for the airline component. The car component upgrade may be defined by the following list of relationships:

ECONOMY is an upgrade to COMPACT

INTERMEDIATE is an upgrade to ECONOMY

STANDARD is an upgrade to INTERMEDIATE

FULL SIZE is an upgrade to STANDARD

PREMIUM is an upgrade to FULL SIZE

LUXURY is an upgrade to PREMIUM

The following car component categories may not have an upgrade:

LUXURY

TRUCK

VAN

CONVERTIBLE

SPORTSCAR

The hotel component upgrade may be defined by the following list of relationships:

ECONOMY is an upgrade to MOTEL

MODERATE is an upgrade to ECONOMY

FIRST is an upgrade to MODERATE

LUXURY is an upgrade to FIRST

LUXURY is an upgrade to RESORT

LUXURY is an upgrade to ALL SUITES

LUXURY is an upgrade to BED & BREAKFAST

LUXURY is an upgrade to HISTORICAL

LUXURY is an upgrade to ALL INCLUSIVE

The following hotel component categories may not have an upgrade:

LUXURY

EXENTED

CONVENTION

RANCH

APARTMENT

In the package level upgrade definitions, the following rules define whether a package can be considered for inclusion in the “Upgrade My Trip” shopping category or not:

I. A package that has no upgrade in car or hotel components is not considered for inclusion in the “Upgrade My Trip” shopping category;

II. A package that has an upgrade in one of either car or hotel and a match or upgrade undefined in the other is considered for inclusion in the “Upgrade My Trip” shopping category;

Ill. A package that has a downgrade in any of the components is not considered for inclusion in the “Upgrade My Trip” shopping category;

IV. If no upgrade is defined for all three of the components no upgrade is defined for package as well and no upgrade tab will be presented to the user.

Similarly to component upgrade level, travel packages also have an upgrade level defined. The package upgrade level may be the sum of the component upgrade levels associated with each of the components of the package. The value of the package upgrade level may range from 0 to 2. It may be 0 when none of its components is an upgrade and it may be 2 when it consists of more than one component; two of the components are car and hotel and each one of them is an upgrade. With an air component upgrade level defined, the value for the package upgrade level may have a range between 0 and 3. Obviously, packages with more upgradeable components may have an even larger range of upgrade levels. Also, a single component may, if necessary, be given two or more distinct upgrade levels, such as, for example, a silver level and a gold level, such that the upgrade level for a single component may vary from 0 to 2 or more.

D.1.2 Dynamic Inputs

The user request input is extracted and provided to optimization engine 130 from a user screen similar to screen shots 200 and 300 (FIGS. 2 and 3). A list of the descriptions of inputs that the user request may consist of is provided below in Table 7.

TABLE 7

| | |
|---|---|
| 1. | Requested travel origin |
| 2. | Travel destination |
| 3. | Currency in which the prices will be expressed |
| 4. | Requested departure date |
| 5. | Preferred departure time |
| 6. | Requested return date |
| 7. | Preferred return time |
| 8. | Is air travel component required |
| | (binary input - 1 if required, 0 if not) |
| 9. | Is car travel component required |
| | (binary input - 1 if required, 0 if not) |
| 10. | Is hotel travel component required |
| | (binary input - 1 if required, 0 if not) |
| 11. | Preferred air component supplier 1 |
| | (air supplier code - e.g. AA, UA etc.) |
| 12. | Preferred air component supplier 2 |
| | (air supplier code - e.g. AA, UA etc.) |
| 13. | Preferred air component supplier 3 |
| | (air supplier code - e.g. AA, UA etc.) |
| 14. | Preferred maximum number of connections in air component |
| 15. | Preferred car component category (e.g. standard, compact, |
| | full size, etc) |
| 16. | Preferred car component supplier (car supplier code - e.g. ZD for |
| | Avis, etc.) |
| 17. | Preferred hotel component type (e.g. first class, luxury etc.) |
| 18. | Preferred hotel component supplier (hotel supplier code) |
| 19. | Preferred hotel property name (property name of preferred hotel) |
| 20. | Distance from point of interest (distance from hotel to selected point |
| | of interest) |

The air travel component input information of a single air component input is provided above in the Introduction section. The air travel components are obtained by querying the GDS 118. A list of the air travel components obtained from the GDS 118 is then sent to optimization engine 130. Consistent with principles related to the present invention, air travel components may be obtained first from the GDS 118 and then car travel components are generated for each air travel component obtained from the GDS 118.

The car travel component input information of a single car component input is provided above in the Introduction section. The car travel components are obtained by querying the GDS system 118, based on times obtained from the user's request for air travel components.

The hotel travel component input information of a single hotel component is provided in the Introduction section. Similar to car travel components, hotel travel components are obtained by querying the GDS 118, based on times obtained from the user's request for air travel components.

D.2 Optimization Engine Outputs

In accordance with the principles of the present invention, optimization engine 130 may generate one set of packages for each of the shopping categories using the inputs provided to it from the GDS 118. In the illustrated embodiment, optimization engine outputs may be represented by three sets of packages each corresponding to one shopping category, although more or less shopping categories and correspondingly more or less sets of packages may be established in other embodiments.

D.2.1 Component Grouping

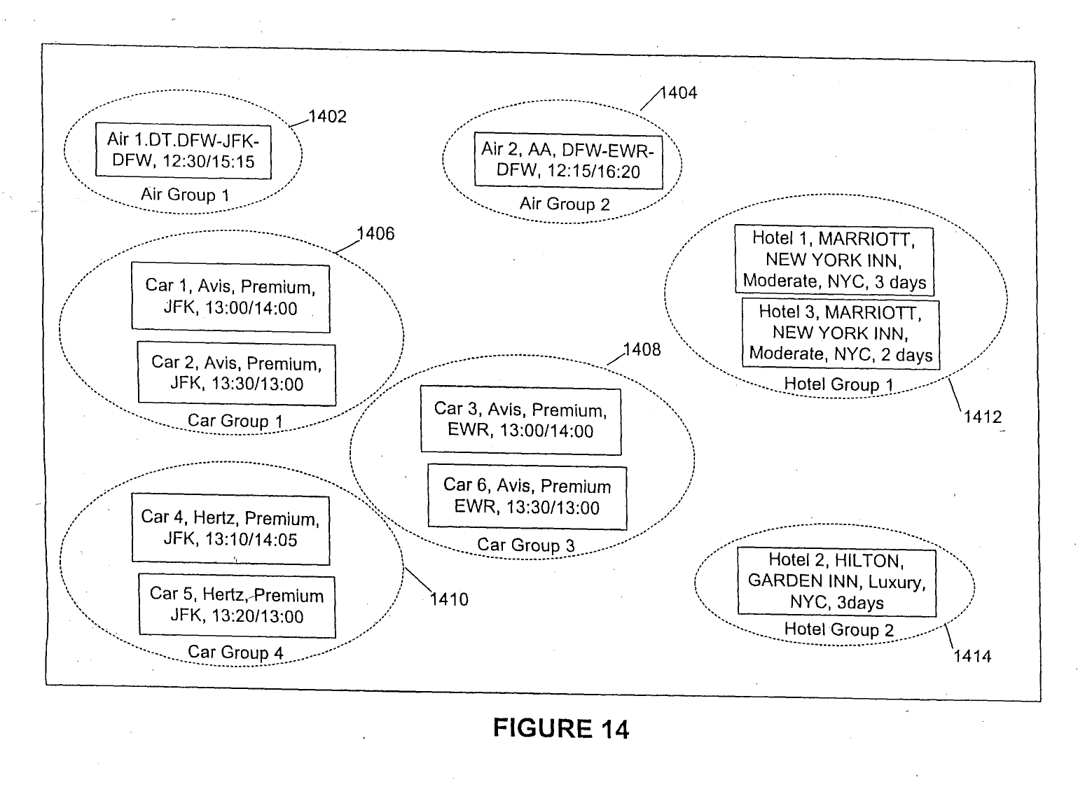

For each user request, optimization engine 130 first retrieves available air components from the GDS 118. Consistent with principles related to the present invention, car and hotel components are retrieved based on the results that the GDS 118 returns for air components in response to the user's requested trip. Due to this process, there will be many car and hotel components that will fit into one air itinerary but not to the other. This may result in large numbers of car components differing only in pick-up\drop-off times and hotels differing only in the number of required days of stay. In order to increase the efficiency of combining the components into packages, optimization engine 130 internally combines these car and hotel components into groups before the process of package generation starts. A few examples of component grouping are shown in FIG. 14.

Each air component, in one implementation of optimization engine 130, represents its own group because, unlike car and hotel components, each air itinerary retrieved from the GDS 118 for purposes of providing a travel package is unique. For example, air groups 1 and 2 (1402 and 1404) each are identified by a unique group. Car components belonging to the same group differ in pick-up\drop-off times only. For example, car groups 1, 3, and 4 (1402-1406) each include the same supplier, location, type of vehicle, and location. Hotel components from the same group differ in number of nights of stay needed. For example, hotel group 1 and 2 (1412 and 1414) each include the same supplier, location, and accommodation type.

D.2.2. Generation of Initial Shopping Category Package Sets

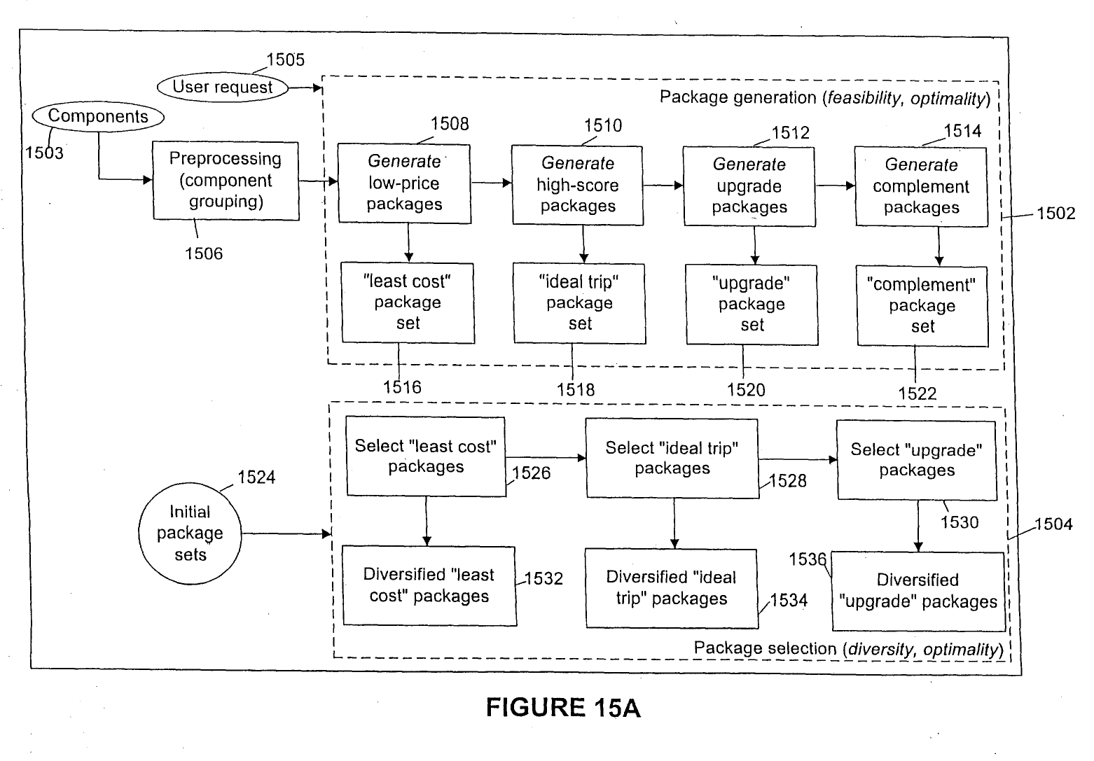

The process of generating initial shopping category package sets is one of the central points of the processes of optimization engine 130. In this step, the trip components retrieved from the GDS 118 are combined into travel packages ready for booking. The overall process is depicted in FIG. 15A.

FIG. 15A illustrates that the process consists of two major steps, package generation 1502 and package selection 1504, and one preprocessing sub-step (component grouping) 1506. Preprocessing sub-step (component grouping) 1506 was discussed above and package generation and package selection steps (1502 and 1504) will be described below.

In package generation step 1502, travel components 1503 are combined to construct travel packages, based on user request 1505. Packages may be generated in an independent search process for each shopping category, or based upon a common search process if desired. FIG. 15A illustrates that a low-price, high-score, and upgrade package generating step (steps 1508-1512, respectively) may be used to generate “least cost,” “ideal trip,” and “upgrade” packages (1516-1520). For each of these search processes, a shopping category-specific value measure may be used to measure the “quality” of the generated packages. For example, packages with a low price are generated for the “least cost” package set 1516, packages with a high-score are generated for the “ideal trip package set 1518, and packages with upgrades are generated for the “upgrade” package set 1520. The mechanism for determining the score for the ideal package set is discussed below and the upgrade constraints used to generate the “upgrade” package set were discussed above in the Static Input section.

In order to strengthen the diversity of the final package set, one additional search process (complement packages generating step 1514) may be run to generate packages that have potentially not been generated in the shopping category-specific search process. In FIG. 15A, the packages generated by the package generating step 1514 are referred to as “complement” packages 1522. Complement packages 1522 may be combined with each of the other three shopping category sets of packages (elements 1516-1520) to provide the input set of packages 1524 for the shopping category-specific selection optimization processes, which will be described in greater detail below.

In the package generating step 1502, to combine the components and generate feasible packages, optimization engine 130 ensures that all necessary constraints between the trip components are enforced. Enforcing these constraints will eliminate component combinations that are not feasible. Two types of constraints may be enforced in this step of the process for each of the shopping category package sets: air\car compatibility constraints, and air\hotel compatibility constraints.

### a. Air\Car Compatibility Constraints

The following are examples of the possible air/car compatibility constraints that may be applied in accord with the principles of the present invention.

1. car pick-up\drop-off location and air itinerary destination location have to be the same;

2. car pick-up date and time has to be maximum p minutes after the arrival date and time of air itinerary destination arrival segment (time p may be a static parameter);

3. car drop-off date and time has to be maximum d minutes before the arrival date and time of air itinerary destination arrival segment (time d is a static parameter)

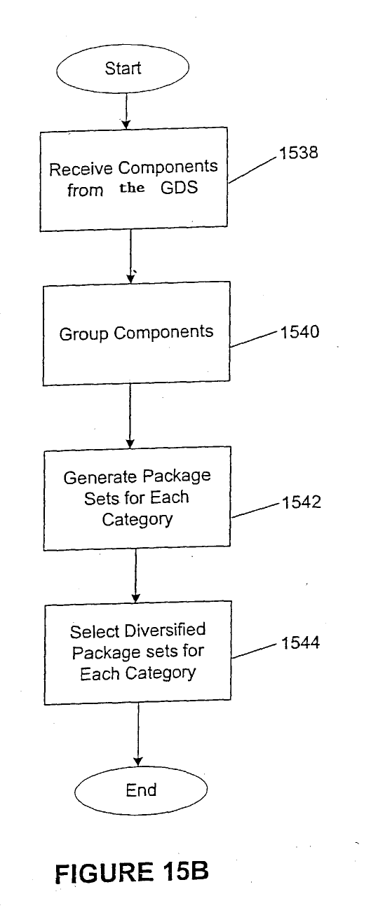

FIG. 16 illustrates an example of the first condition set forth above. Car 2 component 1604 is not compatible with air 1 component 1602 because they are not based in the same location. Air 1 component 1602 is located at John F. Kennedy (JFK) airport and car 2 component 1604 is located at Newark International Airport (EWR). FIG. 16 also provides an example of the second condition set forth above. Car 1 component 1606 is not compatible with air 1 component 1602 because its pick-up time is more than p minutes after the arrival of air 1 component's destination inbound segment.

An example of the third condition set forth above is also depicted in FIG. 16 between car 3 component 1608 and air 1 component 1602. Car 3 component 1608 is not compatible with air 1 component 1602 because its drop-off time is more than d minutes before the departure of air 1 component's destination outbound segment.

In FIG. 16, Car 4 component 1610 is the only car component that meets all three of the air/car compatibility constraints set forth above. Car component 4 1610 is at the same location as air 1 component 1602, it is within p minutes after the arrival of air 1 component 1602 destination inbound segment, and it is within d minutes before the outbound departure of air 1 component 1602.

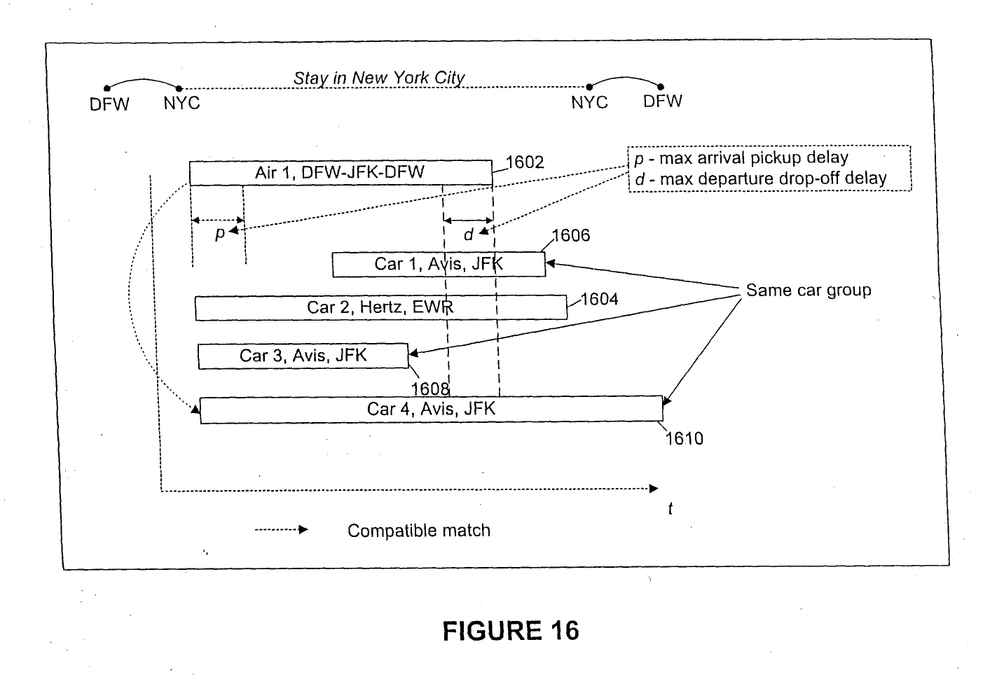

The examples depicted in FIG. 16 deal with individual components regardless of which component group they belong to. However, it is highly likely that more than one car component from a particular car component group is compatible with a single air component. The implementation of these constraints may be such that the constraints will pick up the cheapest car out of the set of matching cars within the same group, as the only one that is compatible with the air component. This case is depicted in FIG. 17 where all three car components (1704, 1706, and 1708) from the same car component group are compatible but only Car 4 (1708) is chosen as the one to be matched with air 1 component (1702) because it is the cheapest one in the compatible car set.

### Air\Hotel Compatibility Constraints

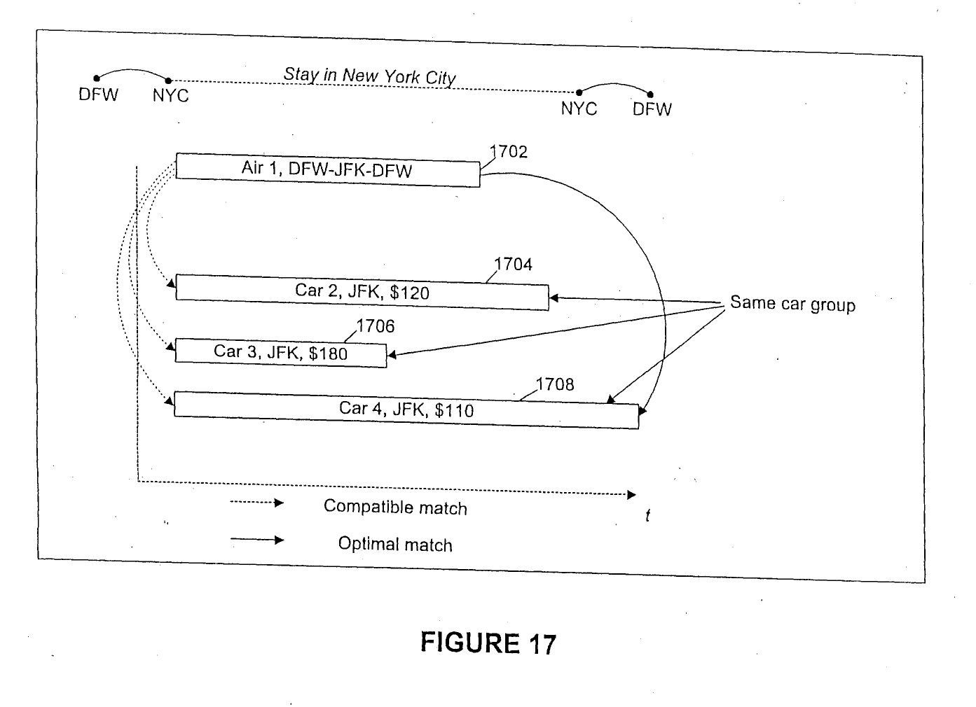

Compatibility between air and hotel components is based on the number of required nights of stay for the selected air component. The nights of stay are computed using the arrival and departure times to and from the air itinerary destination and an inbound Tᵢ and outbound Tₒ threshold parameter. FIG. 18 depicts how this constraint may be applied. Because the destination arrival time of air component 1 1802 is before the inbound threshold Tᵢ, the additional night is needed between days Dᵢ and Dᵢ₊₁. In the case of air component 2 1804, the additional night is not needed between days Dᵢ and Dᵢ₊₁, because its destination arrival time is after the inbound threshold time Tᵢ. The additional night for air component 3 1806 is not needed between days Dᵢ₊₁ and Dᵢ₊₂ because its destination departure time is before outbound threshold time Tₒ. The opposite is true of air component 4 1808 because its destination departure time is after the outbound threshold time Tₒ.

As a result of generating the initial package set, a predetermined number of feasible packages is generated for each of the shopping categories. The number of packages generated for each shopping category set is an engine parameter (N_{LP} for “Lowest priced”, N_{IT} for “Ideal trips”, and Nᵤ for “Upgrades”) that can be controlled and used to adjust the trade-off between the quality of the generated solution and run-time performance of optimization engine 130. The larger the number of the packages generated the greater the diversity of the generated set of packages. Run-time performance of the engine may be inversely proportional to the number of packages generated.

It is important to note that, in most realistic cases, the search for packages may not be complete due to run-time limitations imposed on the application. This may mean that not all possible combinations of packages are found in this step. A set of packages generated and maintained during the package generation search may be the set of best packages found up to the point before the search is interrupted. Shopping category value measure (e.g. price for “Lowest Priced Trips” category) may be used to compare packages within each shopping category package set and determine which packages may be better.

Various types of searches may be conducted to identify packages of the travel components. By way of example, three search strategies are described below:

A search by slice strategy may be used with continuous types of criteria, such as in conjunction with the “Lowest Priced Trips” and the “Ideal Trips” categories. In this search type, a notion of search slice is introduced that represents a region in a travel package search space that contains packages with a continuous criterion value P_{C} between the lower slice bound bs_{L} and upper slice bound bsu (i.e. bs_{L}≦p_{C}≦bs_{U}). The number of search slices n_{S} is computed dynamically using the following formula:

$${n}_{s} = {f}_{s} \cdot \frac{{N}_{P}^{Possible}}{{N}_{P}^{Allowed}}$$

where fₛ is an empirical factor for tuning the number of slices value, N_{P}^{Possible} maximum number of theoretically possible number of packages for a given problem instance and, N_{P}^{Allowed} maximum number of packages allowed for a given search criterion (i.e. price or score).

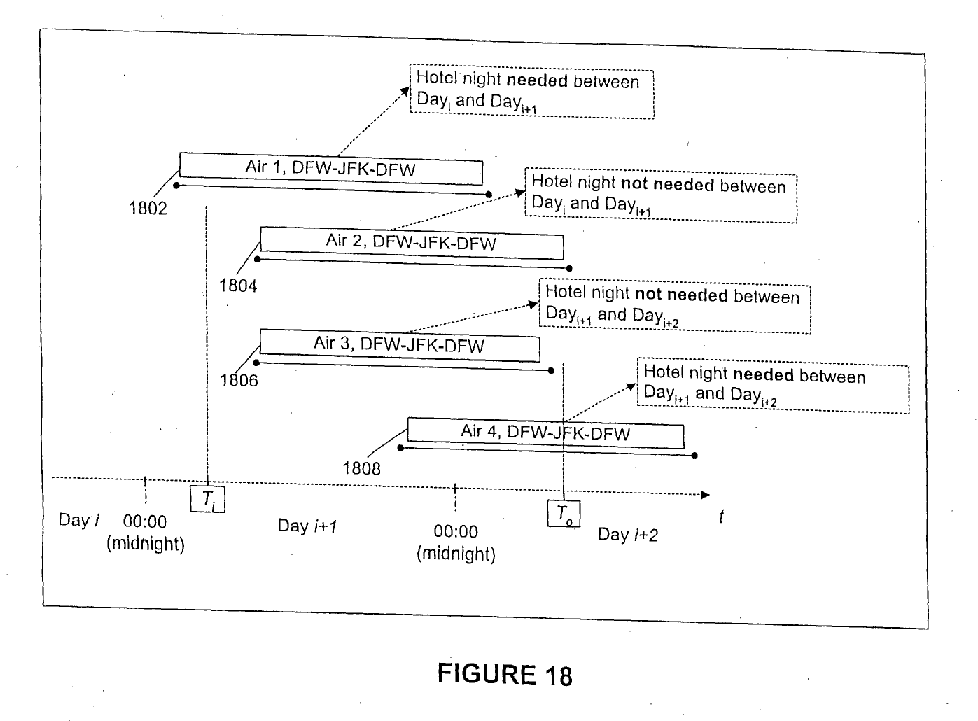

An example package solution space distribution across slices is depicted in FIG. 19 using price as an example criteria. In this figure, packages are represented by small circles. In the case of price, the search proceeds from the lower price boundary of the package search space (marked with LB) towards the upper bound of package search space (marked with UB). In the case of score criterion, the search proceeds in the opposite direction. The lower bound of the search space is found by finding the components with the lowest value for the criterion used (price or score) and adding the value of their criterions together. It is noted that no valid package with the criterion of this value may be available, but using this value as the lower bound insures that the lower bound is going to be lower than the criterion value of the lowest valued valid package. The value of the upper bound of the search space is found in the same manner, but using the components with the highest criterion value.

When searching for the components to be included in a package being currently constructed, the selection strategy is to use the compatible component with the lowest criterion value in the case of minimization of the criterion (e.g. price), or, with the highest criterion value in the case of criterion maximization (e.g. score). This is otherwise known as a best-first-search. According to one embodiment, the package construction strategy proceeds as follows: 1) set the variable that identifies how many components will be included in the purchase (the cardinality variable) to its smallest possible value, 2) configure all connected components not yet configured (if those components consist of other components themselves) and, 3) if all required components are not connected to the package, add a new component and configure it. Each slice is searched exhaustively for all the packages that are contained within it. To reduce the search space within a slice, an additional constraint is added dynamically for each slice that limits the value of the criterion of the packages generated to be within the slice boundaries (bs_{L}≦p_{C}≦bs_{U}). This constraint is removed from the model after the search space within the slice is exhausted or the search is terminated. The search is generally terminated when the number of packages found becomes equal to the parameter that sets the maximum number of packages to be generated. If this parameter is not reached within the time limit set by the total search time parameter, the search is terminated and the packages constructed up to that point returned as a result.

Alternatively, a search by value strategy may be employed with discrete criterion type (e.g. upgrade value). Consequently, the values of slice boundaries are integers. As opposed to search by slice, the number of slices in this step is simply equal to the difference between the upper and lower bound of the search space. Also, instead of the dynamic slice constraint used in the case of search by slice search strategy, the constraint fixing the value of the package with respect to the discrete criterion used is applied within each slice. Using the same notation used when explaining the search by slice, the form of this constraint is P_{C}=bsᵤ. All other aspects of the search are the same as in the case of search by slice strategy.

Yet another search strategy is a diversification search. Often, some components may be missed during the search associated with one of the shopping categories (i.e. either search by slice or search by value). In order to strengthen the diversity of the set of packages generated by the package generation process, the packages containing these missed components may also be generated. This is done using a separate search strategy in which, for each combination of component type and component group, only one such package is generated. The component type around which such package is to be built is chosen first. Any one of the components may be initially selected, with the other components built therearound. Once this choice is made, the search proceeds through each group for that component type in decreasing order of its occurrence in packages generated so far, and generates one package containing that group. Although the diversification search can be configured in different manners, the diversification search may be configured such that for each group of components that has not yet been included in a package or that has been included in fewer than a predefined threshold level of packages, at least one package is generated. Generally, the diversification search proceeds to generate packages for the least frequently utilized groups of components before generating packages for more frequently utilized groups of components. In order to do this, the backtracking is suppressed both for the component belonging to the currently selected component group, as well as for other components to be included in the package. In other words, once compatible components are found, the search returns the package found and proceeds to choose another component group to be used for building the next package. To enable this search strategy, the number of occurrences of each component in the packages generated in previous searches is collected during the search. That is why the diversification search follows the other searches. This search strategy generally uses only time limit for search termination.

D.2.3 Package Selection Step

Shopping categories described in the Systems Operations section are provided in order to make the shopping more convenient and efficient for the user. The number of packages generated in the package generation step may be too large to be presented to the user as a whole because it would destroy the shopping convenience of for the user. In order to maintain the shopping convenience and efficiency for the user, optimization engine 130 may need to limit the size of the set of packages to be shown to the user. This may be accomplished through three parameters—one for each shopping category:

I. N_{TabSize}^{LP}—maximum number of packages selected for “Lowest Priced Trips” category;

II. N_{Tabsize}^{IT}—maximum number of packages selected for “Ideal Trips” category;

III. N_{TabSize}^{U}—maximum number of packages selected for “Upgrade My Trips” category.

Returning to FIG. 15A, the above three parameters may be applied to the initial package sets 1524, which include the “least cost,” “ideal trip,” “upgrade,” and “complement” packages (1516-1522), generated in the package generation step 1502. The above three parameters may be used to select the diversified “least cost,” ideal trip,” and “upgrade,” packages (1532-1536) in package selection step 1504.

A subset of packages may also be selected from the initial package sets 1524 for each shopping category using a predetermined selection criteria. There are two main groups of criteria used in the package subset selection process: package set optimality criteria C_{OPT} and package set diversity criteria C_{DIV}.

The package set optimality criteria (Cₒₚₜ) is based on each shopping category's value measure described in the Systems Operations section (shopping categories definitions). Thus, using this criteria, packages selected for the “Lowest Priced Trips” shopping category may be the least cost packages. Similarly, using this criteria, packages selected for the “Ideal trips” shopping category would be the packages that may be the closest in matching to the user request (i.e. packages with the best score value). Packages selected for the “Upgrade My Trip” category using this criteria, may be the packages that are upgrades to the user request (see definition of upgrade in Static Input section above). Since using the optimality criteria may, in many cases, produce package sets containing only a limited number of travel components, package set diversity criteria (C_{DIV}) may be also used. Package set diversity criteria allows product managers to control the variety of components contained in selected package sets because package set diversity is defined as the number of travel components contained in packages belonging to the set.

Package optimality and package diversity criteria are of such a nature that most of the time they push the solution (the selected package set) in two opposing directions. In other words, optimal packages often tend to be very similar in the components they contain and if only the package optimality criteria is used, selected package sets may have very little diversity of components. Therefore, there is a trade-off between these two package selection criteria. In order to explicitly model this trade-off, an engine parameter called diversity emphasis may be introduced for each shopping category (see Static Input section above (parameter definitions)). By combining this parameter, the criteria described above, and some normalization factors (see the list below the formulas for details), a formula is derived for overall package selection criteria for each shopping category according to one embodiment as follows:

$$\begin{matrix}{obj}^{LP} = Maximize [ \begin{matrix}- \frac{( 1 - {α}_{LP} )}{{N}_{ReqComp} \cdot {LB}^{LP}} \cdot {\sum }_{j = 1}^{{N}_{packages}^{LP}} {price}_{j}^{LP} \cdot {P}_{j}^{LP} + \\ \frac{{α}_{LP}}{{N}_{ReqComTypes} \cdot {N}_{TabSize}^{LP}} \cdot {\sum }_{i = 1}^{{N}_{components}} {C}_{i}^{LP}\end{matrix} ] \\ {obj}^{IT} = Maximize [ \begin{matrix}\frac{( 1 - {α}_{IT} )}{{N}_{ReqComp} \cdot {UB}^{IT}} \cdot {\sum }_{j = 1}^{{N}_{packages}^{IT}} {score}_{j}^{IT} \cdot {P}_{j}^{IT} + \\ \frac{{α}_{IT}}{{N}_{ReqComTypes} \cdot {N}_{TabSize}^{IT}} \cdot {\sum }_{i = 1}^{{N}_{components}} {C}_{i}^{IT}\end{matrix} ] \\ {obj}^{U} = Maximize [ \begin{matrix}\frac{( 1 - {α}_{U} )}{{N}_{ReqComp} \cdot {UB}^{U}} \cdot {\sum }_{j = 1}^{{N}_{packages}^{U}} {upgrade}_{j}^{U} \cdot {P}_{j}^{U} + \\ \frac{{α}_{U}}{{N}_{ReqComTypes} \cdot {N}_{TabSize}^{U}} \cdot {\sum }_{i = 1}^{{N}_{components}} {C}_{i}^{U}\end{matrix} ]\end{matrix}$$

In this formula:

obj^{LP} is a “Lowest Priced Trips” shopping category overall selection criteria and represents the objective function for the “Lowest Priced Trips” category;

obj^{IT} is a “Ideal Trips” shopping category overall selection criteria and represent the objective function for the “Ideal Trips” category;

obj^{U} is a “Upgrade My Trip” shopping category overall selection criteria and represents the objective function for the “Upgrade My Trip” category;

α_{LP} is a diversity emphasis parameter for “Lowest Priced Trips” tab;

α_{IT} is a diversity emphasis parameter for “Ideal Trips” tab;

α_{U} is a diversity emphasis parameter for “Upgrade My Trip” tab;

priceⱼ^{LP} is a price of package j considered for selection in “Lowest Priced Trips” shopping category;

scoreⱼ^{IT} is a score of package j considered for selection in “Ideal Trips” shopping category;

upgradeⱼ^{U} is an upgrade level of package j considered for selection in “Upgrade My Trip” shopping category,

Pⱼ^{LP} ε{0,1} is a 0-1 variable denoting whether package j has been selected (value 1) or not (value 0) for “Lowest Priced Trips” tab,

Pⱼ^{IT} ε{0,1} is a 0-1 variable denoting whether package j has been selected (value 1) or not (value 0) for “Ideal Trips” tab,

Pⱼ^{U} ε{0,1} is a 0-1 variable denoting whether package j has been selected (value 1) or not (value 0) for “Upgrade My Trip” tab,

Cᵢ^{LP} ε{0,1} is a 0-1 variable denoting whether component i has been selected (value 1) or not (value 0) for “Lowest Priced Trips” tab,

Cᵢ^{IT} ε{0,1} is a 0-1 variable denoting whether component i has been selected (value 1) or not (value 0) for “Ideal Trips” tab,

Cᵢ^{U} ε{0,1} is a 0-1 variable denoting whether component i has been selected (value 1) or not (value 0) for “Upgrade My Trip” tab,

N_{packages}^{LP} is a number of packages considered for selection in “Lowest Priced Trips” tab,

N_{packages}^{IT} is a number of packages considered for selection in “Ideal Trips” tab,

N_{packages}^{U} is a number of packages considered for selection in “Upgrade My Trip” tab,

N_{components} is the total number of component groups considered for selection (for example, if there are four groups of cars, two groups of hotels and one group for air travel, N_{components} equals seven,

N_{ReqCompTypes} is a number of required component types in a package (i.e. air, car, and/or hotel),

LB^{LP} is the lowest price value for a component in the current overall package set,

UB^{IT} is the highest score value for a component in the current overall package set,

UB^{U} is the highest upgrade level value for a component in the current overall package set.

Each of the criteria described by the above formulas may be used to maximize the respective objective functions in the optimization-based selection process for its corresponding shopping category. In other words, the selection process implemented in the engine will find the best mix of packages for each shopping category based on the objective function supplied to it. In FIG. 15A, the above formulas used in conjunction with the size limiting parameter described above may be used to select the diversified “least cost”, “ideal trip”, and “upgrade” packages (1532-1536). FIG. 15B (steps 1538-1544) further illustrates the package generation and selection process steps discussed in relation to FIG. 15A.

The first term in each of the objective functions above is the optimality term, while the second one is the diversity term. The negative sign before the optimization (price) term in the “Lowest Priced Trips” shopping category objective function (as opposed to the positive one in the other two objective functions) is derived from the fact that it is desirable to minimize rather than maximize in that objective function. The denominator of each of the terms in each objective function represents the normalization factor used to bring the values of the two terms close together as numbers. If these normalization factors did not exist, the price term, for example, in the first objective function, may have a much higher value than the diversity term. This may result in the diversity term contributing a small proportion of the overall objective function and, thus, not guiding the solution process toward package sets with higher diversity.

The trade-off between package optimality and package diversity will be based on the diversity emphasis parameters (α_{LP},α_{IT}, and α_{U}) set independently for each shopping category. The larger the trade-off parameter the more diverse the resulting selected package set will be, and the less optimal packages will be present in the set.

Tuning selection process parameters are provided for the selection process, which directly affects the quality of the solution generated by the optimization engine 130. Several parameters may be used to control the solution quality:

I. diversity emphasis parameter for price α_{LP};

II. diversity emphasis parameter for score α_{IT};

III. diversity emphasis parameter for upgrade α_{U};

IV. number of packages considered for selection in “Lowest Priced Trips” shopping category N_{packages}^{LP};

V. number of packages considered for selection in “Ideal Trips” shopping category N_{packages}^{IT}; and

VI. number of packages considered for selection in “Upgrade My Trip” shopping category N_{packages}^{U}.

Because of discrete nature of the selected set, the relationship between these parameters and the package set diversity may not be linear. This means that there may be value ranges of these parameters for which the change in the resulting set will not occur until some threshold value in the parameter is reached. This makes tuning these parameters slightly non-intuitive and, thus, should generally be left solely to the discretion of product managers. The parameters may be set independently for different users depending on the users requirements regarding the trade-off and quality of the generated solutions.

D.2.4 Package Modification Process

Package modification may be thought of as the process of customizing a selected travel package. As described in the System Operation section, the user chooses a package to modify and a component type that may be modified. One of the roles of optimization engine 130 in this process may be to find all alternatives for replacement of the chosen component. Another of the optimization engine's roles may be to adjust the other components of the package such that the replacement for the chosen component may be incorporated in the package with as little change as possible. This may be accomplished by fixing the component group for the component types that are not considered for change while allowing any component within the group to be selected for inclusion into the modified package. In this regard, a component group was described above, such as a group of rental cars that differ only in pick-up/drop-off times or a group of hotel rooms that differ only in the required length of stay.

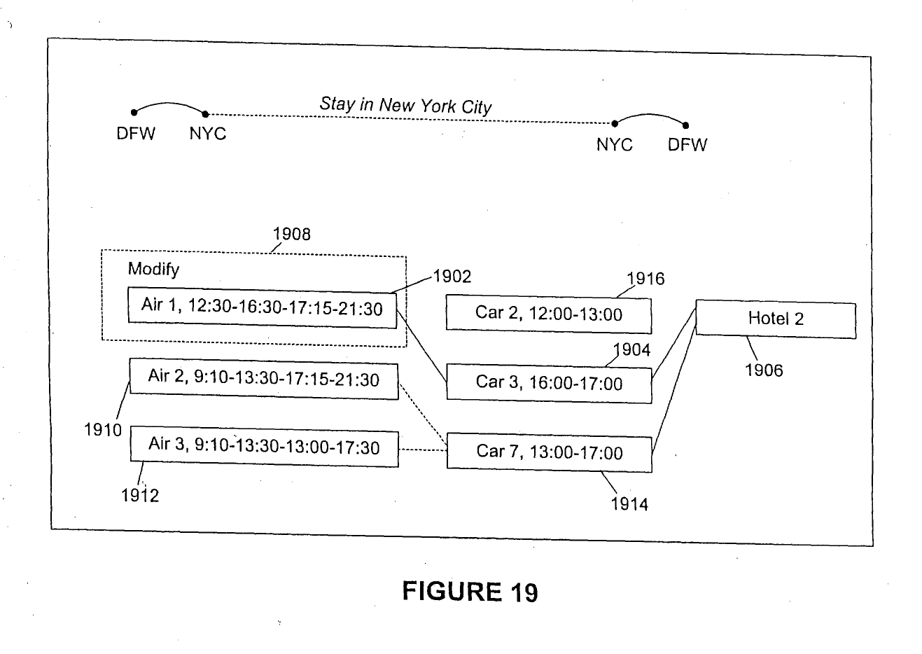

An example of package modification process in the engine is shown in FIG. 20. Initially, package consisting of Air 1 1902, Car 3 1904 and Hotel 2 1906 is chosen for modification. The air component that is to be replaced is framed in “Modify” box 1908. Two other options for air exist: Air 2 1910 and Air 3 1912. If any of those two options is chosen Car 3 1904 cannot be included in the package any more because its pickup time is not in the feasible range of destination arrival time for the other two air components. Car 3 1904 is available at 16:00, when Air 2 1910 and Air 3 1912 arrive at 13:30. In this case, the engine will find the closest replacement for Car 3 1904 such that the chosen replacement for the air component can form a package. In this example, Car 7 1914 may be used as a replacement, but Car 2 cannot be used for the same reason that Car 3 1904 could not be used. Car 7 1914 is within the feasible range of destination arrival time for Air 2 1910 and Air 3 1912. In the case that such a replacement cannot be found in the same component group, a car from another group will be chosen that satisfies the time constraints.

D.2.5 Scoring Mechanism

The objective function described above depends, in part, upon the score of the packages. As their names suggest, the “Lowest Priced Trips” category is scored based on the price of the trip, while the “Upgrade My Trip” category is scored based on the upgrade level of the trip. In one embodiment, however, “Your Ideal Trip” category is scored somewhat differently. In this regard, “Your Ideal Trip” shopping category groups packages that are very close to the description of desired package given by the user request. To determine whether a package should be selected for this category a numeric score as a quantitative measure of “closeness” to the user request is introduced. The computation of the score is entirely handled by optimization engine 130.

Score for a certain package i sᵢ^{P} is computed using a linear sum of weighted component scores sᵢ^{c}. Mathematical formula for computing the package score according to one embodiment is given below:

$${s}_{i}^{p} = {w}_{AIR} \cdot \frac{{\sum }_{j = 1}^{{N}_{a}^{Air}} {w}_{j}^{Air} \cdot {s}_{i j}^{Air}}{{\sum }_{j = 1}^{{N}_{a}^{Air}} {w}_{j}^{Air}} + {w}_{CAR} \cdot \frac{{\sum }_{j = 1}^{{N}_{a}^{Car}} {w}_{j}^{Car} \cdot {s}_{i j}^{Car}}{{\sum }_{j = 1}^{{N}_{a}^{Car}} {w}_{j}^{Car}} + {w}_{HOTEL} \cdot \frac{{\sum }_{j = 1}^{{N}_{a}^{Hotel}} {w}_{j}^{Hotel} \cdot {s}_{i j}^{Hotel}}{{\sum }_{j = 1}^{{N}_{a}^{Hotel}} {w}_{j}^{Hotel}}$$

In this formula:

W_{AIR},(0≦w_{AIR}≦1) is a weight of an air component of a package;

w_{CAR},(0≦w_{CAR}≦1) is a weight of a car component of a package;

w_{HOTEL},(0≦w_{HOTEL}≦1) is a weight of a hotel component of a package;

wₕ^{Air},(0≦wⱼ^{Air}≦1) is a weight of attribute j of air component of a package;

wⱼ^{Car},(0≦wⱼ^{Car}≦1) is a weight of attribute j of car component of a package;

wⱼ^{Hotel},(0≦wⱼ^{Hotel}≦1) is a weight of attribute j of hotel component of a package;

sᵢⱼ^{Air},(0≦sᵢⱼ^{Air}≦1) is a score of attribute j of air component of package I;

sᵢⱼ^{Car},(0≦sᵢⱼ^{Car}≦1) is a score of attribute j of car component of package I;

sᵢⱼ^{Hotel}, (0≦sᵢⱼ^{Hotel}≦1) is a score of attribute j of hotel component of package I;

N_{α}^{Air} is a number of air component attributes;

N_{α}^{Car} is a number of car component attributes; and

N_{α}^{Hotel} is a number of hotel component attributes.

The following relations hold between the component and component attribute weights listed above:

$$\begin{matrix}{w}_{AIR} + {w}_{CAR} + {w}_{HOTEL} = 1 \\ {\sum }_{j = 1}^{{N}_{a}^{Air}} {w}_{j}^{Air} = {\sum }_{j = 1}^{{N}_{a}^{Car}} {w}_{j}^{Car} = {\sum }_{j = 1}^{{N}_{a}^{Hotel}} {w}_{j}^{Hotel} = 1\end{matrix}$$

Package components are scored using component attributes introduced above in the Static Input section (scoring mechanism parameters). These attributes are repeated here together with the description of how their scores may be computed according to one embodiment:

air component supplier score may be computed using the following logic:

if the preferred supplier is undefined, the score is 1.0;

if the component supplier matches any of preferred suppliers from user request, the score is 1.0; and

otherwise, the score is 0.0.

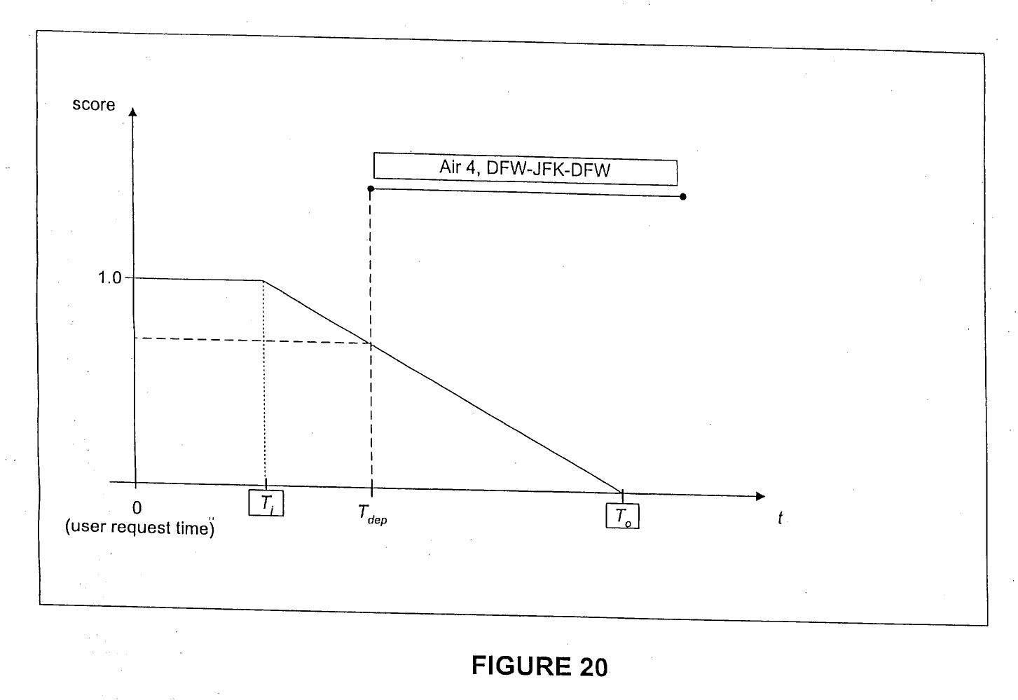

air component departure time score may be computed according to the logic explained below and further illustrated in FIG. 21:

if the departure time delay T_{dep} is less than the inside waiting time threshold Tᵢ, the score is 1.0;

if the departure time delay T_{dep} is between inside waiting time threshold Tᵢ and outside waiting time threshold Tₒ the score is proportional to the difference between Tₒ and Tᵢ and computed using the following formula (this is illustrated in FIG. 11):

$${s}_{dep Time}^{Air} = \frac{{T}_{o} - {T}_{dep}}{{T}_{o} - {T}_{i}} ; and$$

if the departure time delay T_{dep} is greater than the outside waiting time threshold Tₒ, the score is 0.0.

air component return time score may be computed according to the logic explained below and further illustrated in FIG. 21:

if the return time delay Tᵣₑₜ is less than the inside waiting time threshold Tᵢ, the score is 1.0;

if the return time delay Tᵣₑₜ is between inside waiting time threshold Tᵢ and outside waiting time threshold Tₒ the score is proportional to the difference between Tₒ and Tᵢ and computed using the following formula (this is illustrated in FIG. 11):

$${s}_{ret Time}^{Air} = \frac{{T}_{o} - {T}_{ret}}{{T}_{o} - {T}_{i}} ; and$$

if the return time delay Tᵣₑₜ is greater than the outside waiting time threshold Tₒ, the score is 0.0.

air component number of connections score may be computed using the following logic (here N_{OD} represents number of connections between origin and destination, N_{OD} represents number of connections between destination and origin, and Nₘₐₓ is the preferred maximum number of connections specified by user):

if N_{OD}=1 AND N_{DO}=0 than the score is 0.85;

if N_{OD}=0 AND N_{DO}=1 than the score is 0.85;

if N_{OD}=1 AND N_{DO}=1 than the score is 0.66;

if N_{OD}=1 AND N_{DO}=2 than the score is 0.5;

if N_{OD}=2 AND N_{DO}=1 than the score is 0.5;

if N_{OD}=2 AND N_{DO}=0 than the score is 0.5;

if N_{OD}=0 AND N_{DO}=2 than the score is 0.5;

if N_{OD}=2 AND N_{DO}=2 than the score is 0.33;

if N_{OD}≧3 AND N_{DO}<3 than the score is 0.15;

if N_{OD}<3 AND N_{DO}≧3 than the score is 0.15;

if N_{OD}≧3 AND N_{DO}≧3 than the score is 0; and

which may be summarized by the following formula:

$${s}_{OrigDest}^{Air} = \frac{max ( 0 , \frac{3 - {N}_{OD}}{3} ) + max ( 0 , \frac{3 - {N}_{DO}}{3} )}{2} .$$

car component category score may be computed using the following simple logic:

if the preferred car category is undefined, the score is 1.0;

if the car category matches preferred car category, the score is 1.0; and

otherwise, the score is 0.0.

car component supplier score may be computed in a following manner:

if the preferred car supplier is undefined, the score is 1.0;

if the car supplier matches preferred car supplier, the score is 1.0; and

otherwise, the score is 0.0.

hotel component category score may be computed using the following logic:

if the preferred hotel category is undefined, the score is 1.0;

if the hotel category matches preferred hotel category, the score is 1.0; and

otherwise, the score is 0.0.

hotel component supplier score may be computed in the following manner:

if the preferred hotel supplier is undefined, the score is 1.0;

if the hotel supplier matches preferred hotel supplier, the score is 1.0; and

otherwise, the score is 0.0.

hotel component property name score may be computed using the following logic:

if the preferred hotel property name is undefined, the score is 1.0;

if the hotel property name matches preferred hotel property name, the score is 1.0; and

otherwise, the score is 0.0.

hotel component distance from point of interest score may be computed using the following logic:

if the distance from point of interest is less than the maximum distance from point of interest defined by the user, the score is 1.0; and

otherwise, the score is 0.0.

Consistent with principles related to the present invention, optimization engine 130 of one embodiment may only provide, if necessary, the functionality of package scoring and package selection. The component bundling (package generation step) functionality of optimization engine may be required for generating travel packages consisting of two or more travel components such as: air-car, air-hotel, car-hotel, and air-car-hotel.

One skilled in the art will also recognize that many execution and memory schemes can be used to implement the present invention. In addition, single or multiple computer systems may also be used in the implementation of the present invention. Consistent with principles related to the present invention, several components may be executed and contained within a single computer's memory. This memory may be RAM, ROM, other memory structure or a combination thereof. However, this invention may also be implemented using virtual memory, a secondary storage medium and/or across multiple computers. These various configuration issues relate to an implementation preference and are considered within the scope of the present invention.

It will be recognized by one skilled in the art that, while this description discusses the invention in terms of the packaging of items through the Internet, the scope of this invention also includes the packaging of other item that are selected from a database in private networks (e.g. an intranet) and internal computer structures, which allow either various clients and/or servers within a single computer system to exchange information.

The foregoing description of an implementation of the invention has been presented for purposes of illustration and description. It is not exhaustive and does not limit the invention to the precise form disclosed. Modifications and variations are possible in light of the above teachings or may be acquired from practicing the invention.

According to one aspect of the present invention, the system of the present invention, such as the request manager 112 and the optimization engine 130, generally operates under control of a computer program product. The computer program product for performing the methods of embodiments of the present invention includes a computer-readable storage medium, such as the non-volatile storage medium, and computer-readable program code portions, such as a series of computer instructions, embodied in the computer-readable storage medium.

In this regard, flowcharts of methods, systems and program products according to the invention are provided. It will be understood that each block or step of the flowchart, and combinations of blocks in the flowchart, can be implemented by computer program instructions. These computer program instructions may be loaded onto a computer or other programmable apparatus to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that each block or step of the flowchart, and combinations of blocks or steps in the flowchart, can be implemented by special purpose hardware-based computer systems which perform the specified functions or steps, or combinations of special purpose hardware and computer instructions.

Consistent with principles of the present invention, one embodiment of the present invention is implemented using ILOG CPLEX, ILOG Configurator, and ILOG Solver; however, other constraint programming and mathematical programming commercial solvers may be used. For example, Dash Optimization's Xpress modeling and optimization software or IBM Solutions Optimization Solution MIP Solutions may be used in combination with Cosytec's CHIP, Delisoft Ltd's ICE, or Claire to implement the principles of the present invention. The scope of the invention is defined by the claims and their equivalents.

In the foregoing description, three types of travel components (i.e., air component, car component, and hotel component) are considered and used in the methods and systems consistent with the principles of the present invention. Although these three components are considered and used, the embodiments of the present invention are in no way limited to these components. It can be appreciated that the principles of the present invention may be applied to other types of travel components in which it may be advantageous to create package sets based on a request. Additionally, the categories according to which the packages are evaluated and the constraints associated with each category may be varied, as desired, with the foregoing examples provided for illustration only.

That which is claimed is:

1. A method of providing information relating to a plurality of packages of components, comprising:
receiving a request at least partially defining requirements of a desired package of components;
identifying a plurality of candidate packages that comply with the request; and
selecting at least some of the plurality of candidate packages that have been identified in response to the request, wherein selecting at least some of the candidate packages comprises evaluating the candidate packages based upon a diversity criteria relating to the variety of components included within the candidate packages that have been selected.

2. A method according to claim 1 wherein selecting at least some of the candidate packages comprises also evaluating the candidate packages based upon an optimality criteria relating to a value measure of the candidate packages.

3. A method according to claim 2 wherein selecting at least some of the candidate packages comprises selecting a respective subset of the plurality of candidate packages for each of a plurality of different categories of packages, and wherein each category is associated with a different respective value measure.

4. A method according to claim 3 wherein selecting a respective subset of the plurality of candidate packages for each of a plurality of different categories of packages comprises selecting a respective subset of the plurality of candidate packages for at least one of an ideal trips category, a lowest price trips category and an upgrade trips category.

5. A method according to claim 4 wherein selecting a respective subset of the plurality of candidate packages for an ideal trips category comprises evaluating the candidate packages based upon a value measure that differently weights at least some of the components of the candidate packages.

6. A method according to claim 1 wherein evaluating the candidate packages based upon the diversity criteria comprises evaluating the candidate packages based upon the number of different components included within the candidate packages that have been selected.

7. A method according to claim 1 further comprising receiving the diversity criteria that governs the variety of components included within the candidate packages that have been selected.

8. A method according to claim 1 further comprising grouping at least some components prior to identifying the plurality of candidate packages.

9. A method according to claim 8 wherein grouping at least some components comprises retrieving first components and, based on the first components, retrieving other components to be grouped with the first components.

10. A method according to claim 1 further comprising modifying at least one component of at least one candidate package that has been selected to include an alternative component.

11. A method of providing categorized information relating to a plurality of packages of components, comprising:
receiving a request at least partially defining requirements of a desired package of components;
dynamically generating a plurality of candidate packages that comply with and in response to the request; and
selecting a respective subset of the plurality of candidate packages for each of a plurality of different categories of packages, wherein each category is associated with a different respective value measure, and wherein selecting the respective subsets of the candidate packages for each respective category comprises evaluating the candidate packages in accordance with the different respective value measure.

12. A method according to claim 11 wherein selecting a respective subset of the plurality of candidate packages for each of a plurality of different categories of packages comprises selecting a respective subset of the plurality of candidate packages for at least one of an ideal trips category, a lowest price trips category and an upgrade trips category.

13. A method according to claim 11 wherein selecting a respective subset of the plurality of candidate packages for an ideal trips category comprises evaluating the candidate packages based upon a value measure that differently weights at least some of the components of the candidate packages.

14. A method according to claim 11 wherein selecting a respective subset of the plurality of candidate packages for each of a plurality of different categories of packages comprises also evaluating the candidate packages based upon a diversity criteria relating to the variety of components included within the candidate packages that have been selected.

15. A method according to claim 11 further comprising grouping at least some components prior to identifying the plurality of candidate packages.

16. A method according to claim 15 wherein grouping at least some components comprises retrieving first components and, based on the first components, retrieving other components to be grouped with the first components.

17. A method according to claim 11 further comprising modifying at least one component of at least one candidate package that has been selected to include an alternative component.

18. A system of providing information relating to a plurality of packages of components, comprising:
a request manager capable of receiving a request at least partially defining requirements of a desired package of components; and
an optimization engine capable of identifying a plurality of candidate packages that comply with the request, said optimization engine being further capable of selecting at least some of the plurality of candidate packages by evaluating the candidate packages based upon a diversity criteria relating to the variety of components included within the candidate packages that have been selected.

19. A system according to claim 18 wherein said optimization engine is further capable of selecting at least some of the candidate packages by evaluating the candidate packages based upon an optimality criteria relating to a value measure of the candidate packages.

20. A system according to claim 19 wherein said optimization engine is further capable of selecting a respective subset of the plurality of candidate packages for each of a plurality of different categories of packages, and wherein each category is associated with a different respective value measure.

21. A system according to claim 18 wherein said optimization engine is further capable of evaluating the candidate packages based upon the number of different components included within the candidate packages that have been selected.

22. A system for providing categorized information relating to a plurality of packages of components, comprising:
a request manager capable of receiving a request at least partially defining requirements of a desired package of components; and
an optimization engine capable of dynamically generating a plurality of candidate packages that comply with and in response to the request, said optimization engine being further capable of selecting a respective subset of the plurality of candidate packages for each of a plurality of different categories of packages by evaluating the candidate packages in accordance with a different value measures, one of which is associated with each respective category.

23. A system according to claim 22 wherein said optimization engine is capable of selecting a respective subset of the plurality of candidate packages for at least one of an ideal trips category, a lowest price trips category and an upgrade trips category.

24. A system according to claim 23 wherein said optimization engine is capable of selecting a respective subset of the plurality of candidate packages for an ideal trips category by evaluating the candidate packages based upon a value measure that differently weights at least some of the components of the candidate packages.

25. A system according to claim 22 wherein said optimization engine is further capable of evaluating the candidate packages based upon a diversity criteria relating to the variety of components included within the candidate packages that have been selected.

26. A computer program product for providing information relating to a plurality of packages of components, the computer program product comprising a computer-readable storage medium having computer-readable program code portions stored therein, the computer-readable program portions comprising:
a first executable portion for receiving a request at least partially defining requirements of a desired package of components;
a second executable portion for identifying a plurality of candidate packages that comply with the request; and
a third executable portion for selecting at least some of the plurality of candidate packages that have been identified in response to the request, wherein said third executable portion evaluates the candidate packages based upon a diversity criteria relating to the variety of components included within the candidate packages that have been selected.

27. A computer program product according to claim 26 wherein said third executable portion also evaluates the candidate packages based upon an optimality criteria relating to a value measure of the candidate packages.

28. A computer program product according to claim 27 wherein said third executable portion selects a respective subset of the plurality of candidate packages for each of a plurality of different categories of packages, and wherein each category is associated with a different respective value measure.

29. A computer program product according to claim 26 wherein said third executable portion evaluates the candidate packages based upon the number of different components included within the candidate packages that have been selected.

30. A computer program product for providing categorized information relating to a plurality of packages of components, the computer program product comprising a computer-readable storage medium having computer-readable program code portions stored therein, the computer-readable program portions comprising:
a first executable portion for receiving a request at least partially defining requirements of a desired package of components;
a second executable portion for dynamically generating a plurality of candidate packages that comply with and in response to the request; and
a third executable portion for selecting a respective subset of the plurality of candidate packages for each of a plurality of different categories of packages, wherein each category is associated with a different respective value measure, and wherein said third executable portion evaluates the candidate packages in accordance with the different respective value measure.

31. A computer program product according to claim 30 wherein said third executable portion selects a respective subset of the plurality of candidate packages for at least one of an ideal trips category, a lowest price trips category and an upgrade trips category.

32. A computer program product according to claim 30 wherein said third executable portion selects a respective subset of the plurality of candidate packages for an ideal trips category by evaluating the candidate packages based upon a value measure that differently weights at least some of the components of the candidate packages.

33. A computer program product according to claim 30 wherein said third executable portion also evaluates the candidate packages based upon a diversity criteria relating to the variety of components included within the candidate packages that have been selected.
